(19) United States
(12) Patent Application Publication
(10) Pub. No.: US 2024/0092596 A1
(43) Pub. Date: Mar. 21, 2024

(54) TRANSPORTING DEVICE AND PROCESSING SYSTEM

(71) Applicant: FUJIFILM Business Innovation Corp., Tokyo (JP)

(72) Inventors: Raita DOI, Kanagawa (JP); Teisuke Yanagawa, Kanagawa (JP); Katsumi Tanaka, Kanagawa (JP); Tomokazu Kurita, Kanagawa (JP)

(73) Assignee: FUJIFILM Business Innovation Corp., Tokyo (JP)

(21) Appl. No.: 18/161,083

(22) Filed: Jan. 29, 2023

(30) Foreign Application Priority Data
Sep. 21, 2022 (JP) 2022-150569

(51) Int. Cl. B65H 5/18; B41J 11/00; G03G 15/00

(52) U.S. Cl. CPC B65H 5/18; B41J 11/0045; G03G 15/6529; B65H 2404/1424

(57) ABSTRACT

A transporting device includes a carrying-in unit that carries in a sheet-shaped transporting target, a rotation unit that rotates the transporting target, which is carried in by the carrying-in unit, in a view toward a thickness direction, and a discharging unit that discharges the transporting target rotated by the rotation unit.

### CROSS-REFERENCE TO RELATED APPLICATIONS

This application is based on and claims priority under 35 USC 119 from Japanese Patent Application No. 2022-150569 filed Sep. 21, 2022.

### BACKGROUND

### (i) Technical Field

The present invention relates to a transporting device and a processing system.

### (ii) Related Art

US2003/0107169 discloses a sheet transporting device that includes a first shaft including a roller for transporting a sheet and a second shaft, which includes a roller for transporting the sheet and which is disposed at an angle of 90° with respect to the first shaft, and that transports the sheet in different directions by selectively rotating the first shaft and the second shaft.

### SUMMARY

As a transporting device, a transporting device including a carrying-in unit that carries in a sheet-shaped transporting target, a rotation unit that winds the transporting target, which is carried in by the carrying-in unit, around a rotation body such as a roll or a drum and rotates the transporting target in a view toward a width direction of the transporting target, and a discharging unit that discharges the transporting target rotated by the rotation unit, is conceivable.

In this transporting device, for example, front and back sides of the transporting target (one side and the other side in a thickness direction) are reversed in a case where the rotation unit winds the transporting target around the rotation body and rotates the transporting target such that a tip of the transporting target, which faces a downstream side in a carrying-in direction, faces an upstream side in the carrying-in direction.

Aspects of non-limiting embodiments of the present disclosure relate to a transporting device capable of changing an orientation of a transporting target without reversing front and back sides of the transporting target.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transporting device including a carrying-in unit that carries in a sheet-shaped transporting target, a rotation unit that rotates the transporting target, which is carried in by the carrying-in unit, in a view toward a thickness direction, and a discharging unit that discharges the transporting target rotated by the rotation unit.

### BRIEF DESCRIPTION OF THE DRAWINGS

Exemplary embodiment(s) of the present invention will be described in detail based on the following figures, wherein:

FIG. 1 is a side view illustrating an outline of a processing system according to the present exemplary embodiment;

FIG. 2 is a plan view illustrating an outline of the processing system according to the present exemplary embodiment;

FIG. 3 is a schematic view illustrating an outline of an image forming apparatus in a pre-processing apparatus according to the present exemplary embodiment;

FIG. 4 is a schematic view illustrating an outline of a post-processing apparatus according to the present exemplary embodiment;

FIG. 5 is a side view illustrating an outline of a transporting device according to the present exemplary embodiment;

FIG. 6 is a plan view illustrating an outline of the transporting device according to the present exemplary embodiment;

FIG. 7 is a side view illustrating an outline of a guide mechanism and a first transporting portion according to the present exemplary embodiment;

FIG. 8 is a side view illustrating a state in which a guide member is positioned at a carrying-in position in a configuration illustrated in FIG. 7;

FIG. 9 is a side view illustrating an outline of a second transporting portion and a movement mechanism according to the present exemplary embodiment;

FIG. 10 is a perspective view illustrating an outline of the second transporting portion according to the present exemplary embodiment;

FIG. 11 is a plan cross-sectional view illustrating an outline of the second transporting portion and the movement mechanism according to the present exemplary embodiment;

FIG. 12 is a side view illustrating an outline of a third transporting portion and the movement mechanism according to the present exemplary embodiment;

FIG. 13 is a plan cross-sectional view illustrating an outline of the third transporting portion and the movement mechanism according to the present exemplary embodiment;

FIG. 14 is a side cross-sectional view illustrating an outline of a rotation mechanism according to the present exemplary embodiment;

FIG. 15 is a side cross-sectional view illustrating a state in which a disposition member is positioned at a contact position in the rotation mechanism according to the present exemplary embodiment;

FIG. 16 is a side cross-sectional view illustrating a state in which the disposition member is positioned at a separation position in the rotation mechanism according to the present exemplary embodiment;

FIG. 17 is a plan view illustrating an outline of the rotation mechanism according to the present exemplary embodiment;

FIG. 18 is a plan view illustrating a state in which the rotation mechanism according to the present exemplary embodiment rotates a recording medium;

FIG. 19 is a side view illustrating an outline of the transporting device according to the present exemplary embodiment;

FIG. 20 is a plan view illustrating an outline of a transporting device according to a modification example; and

FIG. 21 is a plan view illustrating a connection of the transporting device according to the modification example.

### DETAILED DESCRIPTION

An example of an exemplary embodiment of the present invention will be described below with reference to the drawings.

Processing System 100

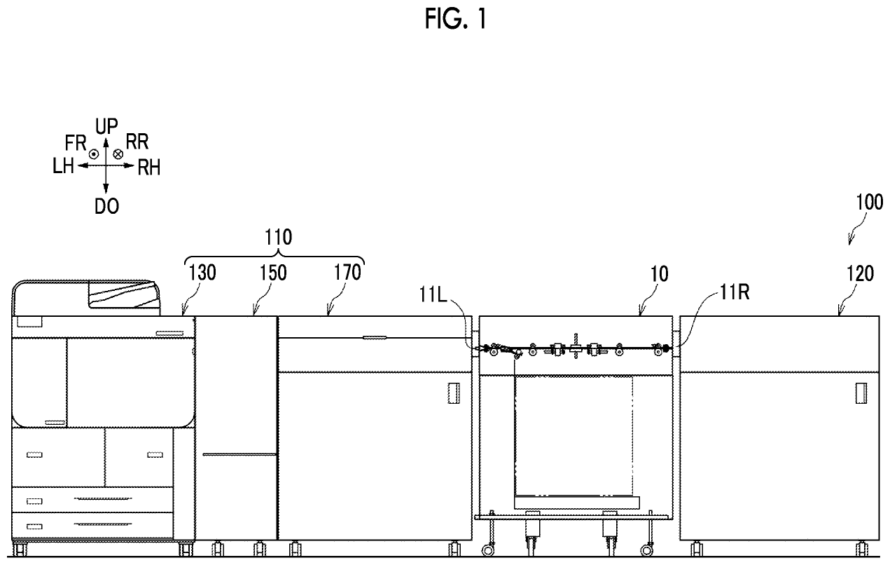

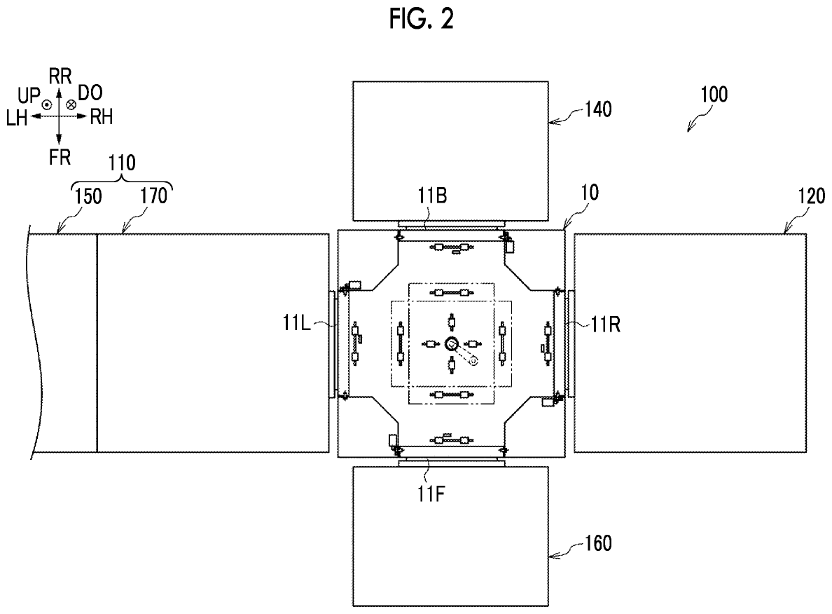

First, a processing system 100 according to the present exemplary embodiment will be described. FIG. 1 and FIG. 2 are schematic views illustrating the processing system 100 according to the present exemplary embodiment.

An arrow UP illustrated in the figure indicates an up side of an apparatus, and an arrow DO indicates a down side of the apparatus. Further, an arrow LH illustrated in the figure indicates a left side of the apparatus, and an arrow RH indicates a right side of the apparatus. Further, an arrow FR illustrated in the figure indicates a front side of the apparatus, and an arrow RR indicates a rear side of the apparatus. Since these directions are directions determined for convenience of description, a configuration of the apparatus is not limited to these directions. The term “apparatus” may be omitted in each direction of the apparatus. That is, for example, the “up side of the apparatus” may be simply referred to as the “up side”.

Further, in the following description, an “up-down direction” may be used to describe “both the up side and the down side” or “either one of the up side or the down side”. The term “right-left direction” may be used to describe “both the right side and the left side” or “either one of the right side or the left side”. The “right-left direction” can also be said to be a side, a lateral direction, and a horizontal direction. The term “front-rear direction” may be used to describe “both the front side and the rear side” or “either one of the front side or the rear side”. The “front-rear direction” can also be said to be a side, a lateral direction, and a horizontal direction. Further, the up-down direction, the right-left direction, and the front-rear direction are directions intersecting each other (specifically, directions orthogonal to each other).

Further, a symbol in which “x” is described in “o” in the figure describes an arrow from the front to the back of the paper. Further, a symbol in which “•” is described in “o” in the figure describes an arrow from the back to the front of the paper. Further, a dimensional ratio of each of the parts illustrated in each of the figures in the up-down direction, the right-left direction, and the front-rear direction may differ from the actual dimensional ratio.

The processing system 100 is a system that executes predetermined processing and includes a pre-processing apparatus 110, a post-processing apparatus 120, and a transporting device 10 as illustrated in FIG. 1. The processing system 100 further includes post-processing apparatuses 140 and 160 as illustrated in FIG. 2.

Pre-Processing Apparatus 110

The pre-processing apparatus 110 is an apparatus that executes pre-processing on a transporting target. Specifically, the pre-processing apparatus 110 includes an image forming apparatus 130 and transporting devices 150 and 170.

Image Forming Apparatus 130

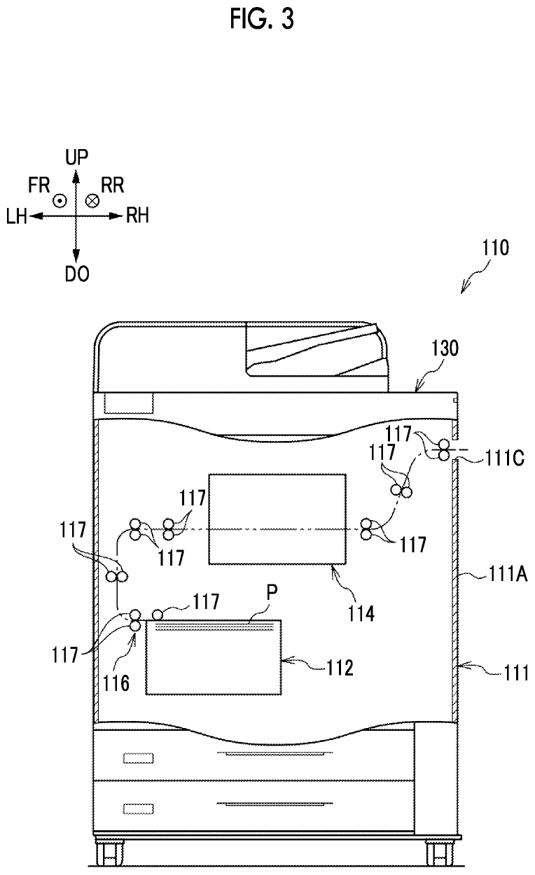

The image forming apparatus 130 is an apparatus that forms an image on a recording medium P as pre-processing. As illustrated in FIG. 3, the image forming apparatus 130 includes an apparatus main body 111, a medium accommodation portion 112, an image forming portion 114 as a pre-processing portion, and a transporting mechanism 116. The recording medium P is an example of a transporting target.

Apparatus Main Body 111

The apparatus main body 111 illustrated in FIG. 3 is a part where each configuration portion of the pre-processing apparatus 110 is provided. The apparatus main body 111 includes a box-shaped housing 111A that accommodates each configuration portion of the pre-processing apparatus 110. In the present exemplary embodiment, as illustrated in FIG. 3, for example, the medium accommodation portion 112, the image forming portion 114, and the transporting mechanism 116 are provided inside the apparatus main body 111.

Medium Accommodation Portion 112

As illustrated in FIG. 3, the medium accommodation portion 112 is a part where the recording medium P is accommodated in the pre-processing apparatus 110. The recording medium P, which is accommodated in the medium accommodation portion 112, is supplied to the image forming portion 114. As the recording medium P, for example, paper is used.

Image Forming Portion 114

The image forming portion 114 illustrated in FIG. 3 is a configuration portion that forms an image on the recording medium P, which is sent out from the medium accommodation portion 112, as pre-processing. As the image forming portion 114, for example, an electrophotographic type image forming portion, which forms an image on the recording medium P by using toner, is used.

In the electrophotographic type image forming portion, for example, each process of charging, exposure, development, transfer, and fixing is performed to form an image on the recording medium P. As the electrophotographic type image forming portion, each process of charging, exposure, development, and transfer may be performed to form an image on a transfer body, and an image may be formed on the recording medium P by transferring the image from the transfer body to the recording medium P and then fixing the image on the recording medium P.

The example of the image forming portion is not limited to the electrophotographic type image forming portion described above, and may be, for example, an ink jet type image forming portion, and various image forming portions can be used. In the ink jet type image forming portion, for example, ink droplets are ejected from an ejection portion to the recording medium P to form an image on the recording medium P.

Transporting Mechanism 116

The transporting mechanism 116 illustrated in FIG. 3 is a mechanism that transports the recording medium P. As an example, the transporting mechanism 116 transports the recording medium P by using a transporting member 117 such as a transporting roll. The transporting member 117 may be a transporting belt or the like and may be any member as long as the transporting member can transport the recording medium P by applying a transporting force to the recording medium P.

The transporting mechanism 116 transports the recording medium P from the medium accommodation portion 112 to the image forming portion 114. Further, the transporting mechanism 116 transports the recording medium P to a discharging port 111C provided in the apparatus main body 111.

Transporting Devices 150 and 170

The transporting devices 150 and 170 are devices that transport the recording medium P, on which an image is formed by the image forming apparatus 130 as the pre-processing.

The transporting devices 150 and 170 include a transporting mechanism (not illustrated) that transports the recording medium P. As an example, the transporting mechanism transports the recording medium P by using a transporting member (not illustrated) such as a transporting roll. The transporting member may be a transporting belt or the like and may be any member as long as the transporting member can transport the recording medium P by applying a transporting force to the recording medium P.

The transporting devices 150 and 170 may include a correction function of correcting a curvature (so-called curl) of the recording medium P, a cooling function of cooling the recording medium P, and an adjusting function of adjusting processing timings of the pre-processing and the post-processing by temporarily holding the recording medium P, which is transported from the image forming apparatus 130, and then transporting the recording medium P to the transporting device 10, in addition to a function of transporting the recording medium P.

Regarding Pre-Processing

Here, the pre-processing is processing executed on the transporting target before the transporting target is transported by the transporting device 10. The pre-processing apparatus 110 may be configured with a plurality of apparatuses as in the present exemplary embodiment or may be configured with a single apparatus. Therefore, as the pre-processing, plurality of processing may be executed, or single processing may be executed.

Further, in the present exemplary embodiment, image forming processing of forming an image and transporting processing of transporting the transporting target are executed as the pre-processing, but the present exemplary embodiment is not limited thereto. The pre-processing may be, for example, image reading processing of reading an image of the transporting target, sending out processing of sending out the transporting target, or the like, and may be processing that is executed before the transporting target is transported by the transporting device 10.

Post-Processing Apparatus 120

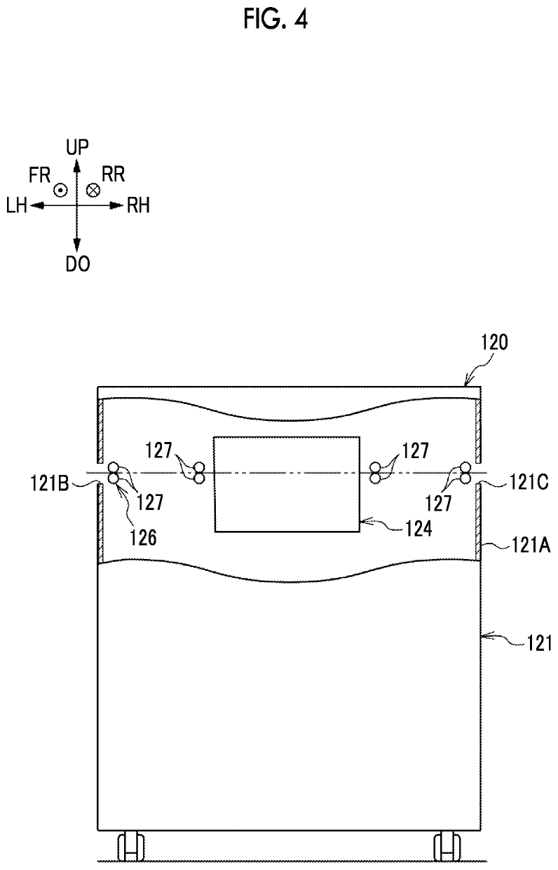

FIG. 4 is a schematic view illustrating the post-processing apparatus 120. The post-processing apparatus 120 is an apparatus that executes post-processing on the recording medium P. Specifically, as illustrated in FIG. 4, the post-processing apparatus 120 includes an apparatus main body 121, a post-processing portion 124, and a transporting mechanism 126. The post-processing apparatus 120 is connected to a discharging port 11R, which will be described later, in the transporting device 10.

Apparatus Main Body 121

The apparatus main body 121 illustrated in FIG. 4 is a part where each configuration portion of the post-processing apparatus 120 is provided. The apparatus main body 121 includes a box-shaped housing 121A that accommodates each configuration portion of the post-processing apparatus 120. In the present exemplary embodiment, as illustrated in FIG. 4, for example, the post-processing portion 124 and the transporting mechanism 126 are provided inside the apparatus main body 121.

Post-Processing Portion 124

The post-processing portion 124 illustrated in FIG. 4 is a configuration portion that executes predetermined post-processing on the recording medium P transported from the transporting device 10. Specifically, as the post-processing, the post-processing portion 124 executes, for example, book-binding processing of book-binding a plurality of recording media P.

Here, the post-processing is processing executed on the transporting target after the transporting target is transported by the transporting device 10. In the post-processing apparatus 120, the post-processing portion 124 executes the book-binding processing, but the present exemplary embodiment is not limited thereto. The post-processing may be, for example, binding processing of binding a plurality of the recording media P, folding processing of folding the transporting target, cutting processing of cutting the transporting target, hole punching processing of punching a hole in the transporting target, or the like, and may be processing that is executed after the transporting target is transported by the transporting device 10. Further, in a case where the sending out processing of sending out the transporting target is executed as the pre-processing, the image forming processing of forming an image may be executed as the post-processing.

Transporting Mechanism 126

The transporting mechanism 126 illustrated in FIG. 4 is a mechanism that transports the recording medium P. As an example, the transporting mechanism 126 transports the recording medium P by using a transporting member 127 such as a transporting roll. The transporting member 127 may be a transporting belt or the like and may be any member as long as the transporting member can transport the recording medium P by applying a transporting force to the recording medium P.

The transporting mechanism 126 transports the recording medium P from an inlet port 121B, which is provided in the apparatus main body 121, to the post-processing portion 124. Further, the transporting mechanism 126 transports the recording medium P from the post-processing portion 124 to a discharging port 121C provided in the apparatus main body 121.

Post-Processing Apparatuses 140 and 160

The post-processing apparatuses 140 and 160 illustrated in FIG. 2 are apparatuses that execute the post-processing and have the same configuration as the post-processing apparatus 120 except that the post-processing, which is executed by the post-processing portion, is different. Each of the post-processing apparatuses 140 and 160 executes, for example, the book-binding processing of a method different from that of the post-processing apparatus 120. The post-processing apparatus 140 is connected to the discharging port 11R, which will be described later, in the transporting device 10, and the post-processing apparatus 160 is connected to a discharging port 11F, which will be described later, in the transporting device 10.

The post-processing, which is executed by the post-processing apparatuses 140 and 160, may be, for example, binding processing of binding a plurality of the recording media P, folding processing of folding the transporting target, cutting processing of cutting the transporting target, hole punching processing of punching a hole in the transporting target, or the like, and may be processing that is executed after the transporting target is transported by the transporting device 10. Further, the post-processing, which is executed by the post-processing apparatuses 140 and 160, may be post-processing same as the post-processing executed by the post-processing apparatus 120.

The post-processing apparatuses 140 and 160 may be, for example, apparatuses in which a front surface of the apparatus where a user operates or the like is present on either the right side or the left side in FIG. 2. Therefore, as the post-processing apparatus 140, for example, an apparatus in which the right side in FIG. 2 is set as the front surface of the apparatus and the recording medium P is carried in from the left side of the apparatus can be used. Further, as the post-processing apparatus 140, for example, an apparatus in which the left side in FIG. 2 is set as the front surface of the apparatus and the recording medium P is carried in from the right side of the apparatus can be used.

Further, as the post-processing apparatus 160, for example, an apparatus in which the left side in FIG. 2 is set as the front surface of the apparatus and the recording medium P is carried in from the left side of the apparatus can be used. Further, as the post-processing apparatus 160, for example, an apparatus in which the right side in FIG. 2 is set as the front surface of the apparatus and the recording medium P is carried in from the right side of the apparatus can be used.

Transporting Device 10

The transporting device 10 illustrated in FIG. 2 is a device that transports the recording medium P, which is transported from the pre-processing apparatus 110, to the post-processing apparatuses 120, 140, and 160. Specifically, the transporting device 10 carries in the recording medium P, which is transported from the pre-processing apparatus 110, from a carrying-in port 11L and discharges the carried-in recording medium P from any of discharging ports 11F, 11B, or 11R. That is, the transporting device 10 has a function of selectively transporting the recording medium P to any of the plurality of post-processing apparatuses 120, 140, or 160 (see FIG. 2).

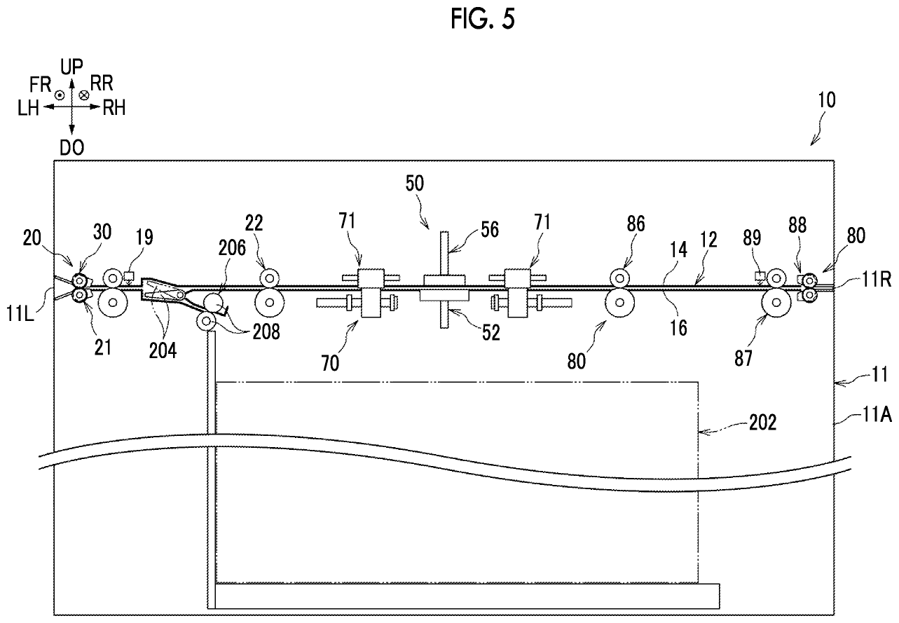

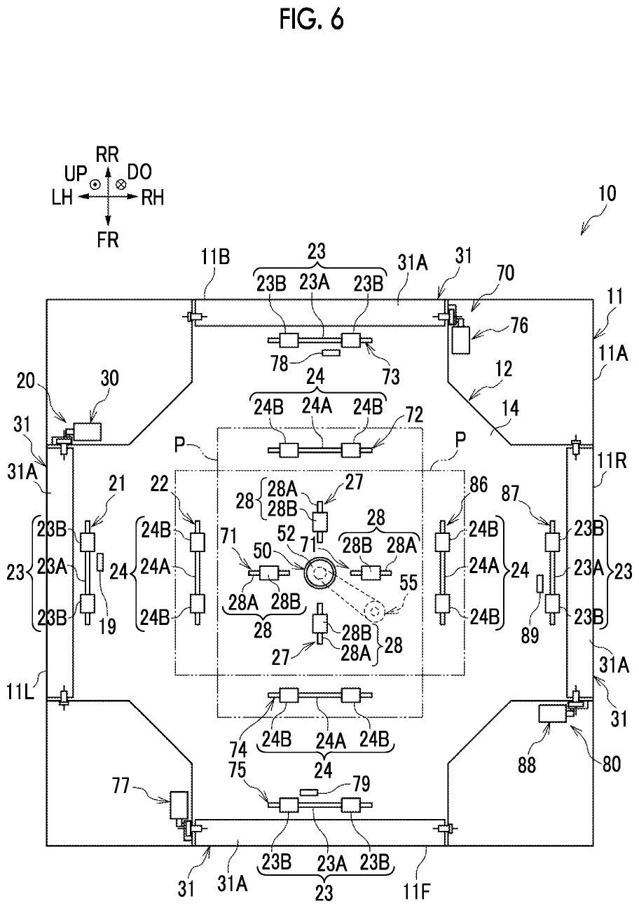

FIG. 5 is a side view illustrating an outline of the transporting device 10. FIG. 6 is a plan view illustrating an outline of the transporting device 10. Specifically, the transporting device 10 includes a device main body 11, a guide portion 12, a carrying-in mechanism 20, a rotation mechanism 50, a discharging mechanism 70, and a discharging mechanism 80.

Hereinafter, the recording medium P, which is defined as the transporting target of the transporting device 10, and each part of the transporting device 10 will be described.

Recording Medium P

The recording medium P is specifically paper and is an example of a sheet-shaped transporting target. Here, the term “sheet-shaped” is a shape in which a dimension in a thickness direction that intersects the carrying-in direction in the transporting device 10 is smaller than a dimension in the carrying-in direction and a dimension in a width direction that intersects the carrying-in direction and the thickness direction.

Note that the example of the transporting target is not limited to paper. As an example of the transporting target, for example, a film or the like may be used, and any sheet-shaped target that can be transported by the transporting device 10 may be used.

Device Main Body 11

The device main body 11 illustrated in FIGS. 5 and 6 is a part where each configuration portion of the transporting device 10 is provided. The device main body 11 includes a box-shaped housing 11A that accommodates each configuration portion of the transporting device 10. In the present exemplary embodiment, as illustrated in FIGS. 5 and 6, for example, the guide portion 12, the carrying-in mechanism 20, the rotation mechanism 50, the discharging mechanism 70, and the discharging mechanism 80 are provided inside the device main body 11.

As illustrated in FIG. 6, the device main body 11 includes the carrying-in port 11L in which the recording medium P is carried in from the outside to the inside of the device main body 11 and the discharging ports 11F, 11B, and 11R that discharge the recording medium P from the inside to the outside of the device main body 11.

The carrying-in port 11L is formed on a left side surface of the device main body 11. The discharging port 11F is formed on a front surface of the device main body 11. The discharging port 11B is formed on a rear surface of the device main body 11. The discharging port 11R is formed on a right side surface of the device main body 11.

In other words, in the present exemplary embodiment, an opening, which is formed on the left side surface of the device main body 11, is used as the carrying-in port 11L, and openings, which are formed in each of the front surface, the rear surface, and the right side surface of the device main body 11, are used as the discharging ports 11F, 11B, and 11R, respectively.

In the present exemplary embodiment, as described above, the device main body 11 is formed with four openings, which are the carrying-in ports or the discharging ports, and is formed in a rectangular shape in a plan view.

Guide Portion 12

The guide portion 12 illustrated in FIGS. 5 and 6 is a configuration portion that guides the recording medium P transported by the transporting device 10. Specifically, as illustrated in FIG. 5, the guide portion 12 includes a first facing member 14 that faces one side (specifically, an upper side) of the recording medium P and a second facing member 16 that faces the other side (specifically, a lower side) of the recording medium P. Each of the first facing member 14 and the second facing member 16 is configured with a frame formed in a plate shape having the up-down direction as the thickness direction.

Each of the first facing member 14 (specifically, a lower surface) and the second facing member 16 (specifically, an upper surface) guides the recording medium P by being in contact with the recording medium P. In other words, the lower surface of the first facing member 14 and the upper surface of the second facing member 16 form a transporting path surface on which the recording medium P is transported.

Carrying-in Mechanism 20

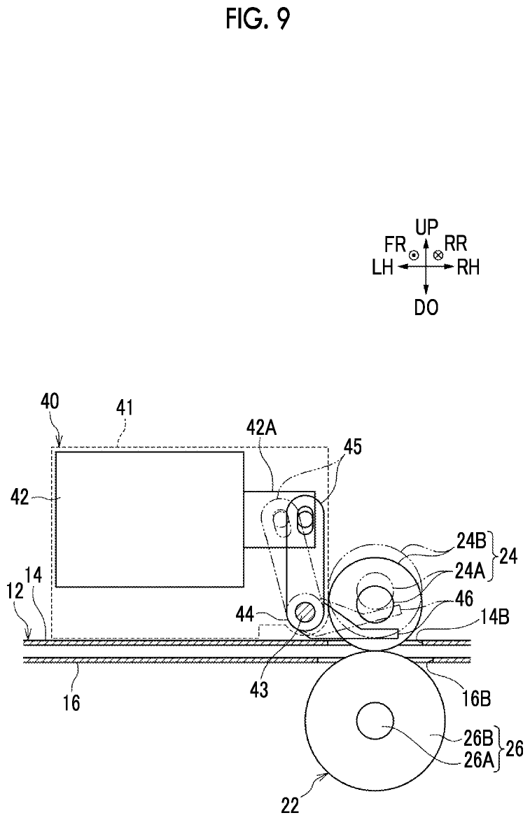

The carrying-in mechanism 20 illustrated in FIGS. 5 and 6 is an example of a carrying-in unit and is a mechanism that carries in the recording medium P. Specifically, the carrying-in mechanism 20 carries the recording medium P into the rotation mechanism 50 (specifically, a contact member 52 described later). In the present exemplary embodiment, as illustrated in FIGS. 5 and 6, the carrying-in mechanism 20 includes a guide mechanism 30, a first transporting portion 21, a second transporting portion 22, a movement mechanism 40 (see FIG. 9), a pair of third transporting portions 27, and a detection portion 19.

Guide Mechanism 30

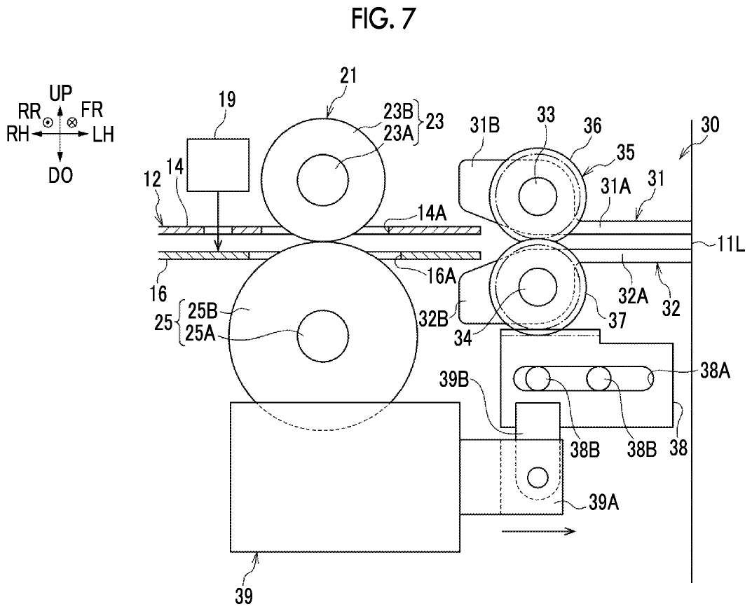

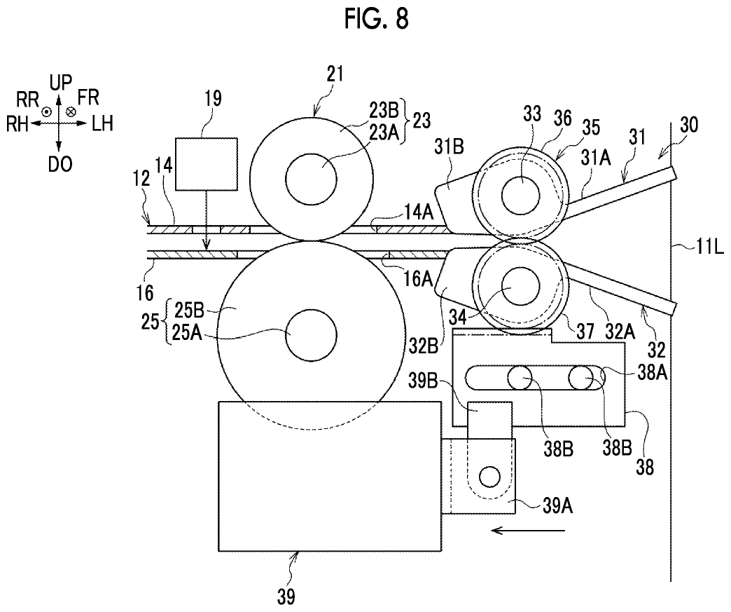

FIG. 7 and FIG. 8 are side views illustrating an outline of the guide mechanism 30 and the first transporting portion 21. As illustrated in FIGS. 7 and 8, the guide mechanism 30 is provided at the carrying-in port 11L and is a mechanism that guides the recording medium P. The guide mechanism 30 includes a pair of guide members 31 and 32, a transmission portion 35, and a drive portion 39.

The guide member 31 includes a main body portion 31A, which is formed in a plate shape having the up-down direction as the thickness direction, and a pair of side portions 31B rising to the upper side from each of a front end portion and a rear end portion of the main body portion 31A.

The main body portion 31A is formed in a rectangular shape having a length in the front-rear direction in a plan view (see FIG. 6). The guide member 31 is supported to be rotatable by each of the pair of shaft portions 33 penetrating each of the pair of side portions 31B. Specifically, the guide member 31 is supported to be rotatable at a discharging position (a position illustrated in FIG. 7) and a carrying-in position (a position illustrated in FIG. 8).

The discharging position (the position illustrated in FIG. 7) is a position used in a case where the recording medium P is discharged from the inside to the outside of the device main body 11. The carrying-in position (the position illustrated in FIG. 8) is a position used in a case where the recording medium P is carried in from the outside to the inside of the device main body 11.

The guide member 31 becomes in a state in which the lower surface of the main body portion 31A is aligned with the lower surface of the first facing member 14 of the guide portion 12 in a side view at the discharging position (the position illustrated in FIG. 7). Specifically, the guide member 31 becomes in a state in which the lower surface of the main body portion 31A is aligned in the horizontal direction in a side view at the discharging position (the position illustrated in FIG. 7). The guide member 31 becomes in a state of being inclined obliquely upper side to the left in a side view at the carrying-in position (the position illustrated in FIG. 8).

Further, in FIG. 7 and FIG. 8, among the pair of side portions 31B, only the side portion 31B, which is disposed on the rear side of the main body portion 31A, is illustrated, among the pair of shaft portions 33, only the shaft portion 33, which is disposed on the rear side of the main body portion 31A, is illustrated.

The guide member 32 includes a main body portion 32A, which is formed in a plate shape having the up-down direction as the thickness direction, and a pair of side portions 32B extending to the lower side from each of a front end portion and a rear end portion of the main body portion 32A.

The main body portion 32A is formed in a rectangular shape having a length in the front-rear direction in a plan view. The guide member 32 is supported to be rotatable by each of the pair of shaft portions 34 penetrating each of the pair of side portions 32B. Specifically, the guide member 32 is supported to be rotatable at a discharging position (a position illustrated in FIG. 7) and a carrying-in position (a position illustrated in FIG. 8).

The discharging position (the position illustrated in FIG. 7) is a position used in a case where the recording medium P is discharged from the inside to the outside of the device main body 11. The carrying-in position (the position illustrated in FIG. 8) is a position used in a case where the recording medium P is carried in from the outside to the inside of the device main body 11.

The guide member 32 becomes in a state in which the upper surface of the main body portion 32A is aligned with the upper surface of the second facing member 16 of the guide portion 12 in a side view at the discharging position (the position illustrated in FIG. 7). Specifically, the guide member 32 becomes in a state in which the upper surface of the main body portion 32A is aligned in the horizontal direction in a side view at the discharging position (the position illustrated in FIG. 7).

The guide member 32 becomes in a state of being inclined obliquely lower side to the left in a side view at the carrying-in position (the position illustrated in FIG. 8). As a result, an interval between tip portions (left end portions) of the guide member 32 and the guide member 31 is larger than that in the case where the guide member 32 and the guide member 31 are positioned at the discharging position.

Further, in FIG. 7 and FIG. 8, among the pair of side portions 32B, only the side portion 32B, which is disposed on the rear side of the main body portion 32A, is illustrated, among the pair of shaft portions 34, only the shaft portion 34, which is disposed on the rear side of the main body portion 32A, is illustrated.

The drive portion 39 is a configuration portion that generates a driving force for rotating the guide members 31 and 32. Specifically, the drive portion 39 is configured with a solenoid that moves a movable shaft 39A in the shaft direction.

The transmission portion 35 is a configuration portion that transmits the driving force of the drive portion 39 to the guide members 31 and 32 to rotate the guide members 31 and 32 between the discharging position (the position illustrated in FIG. 7) and the carrying-in position (the position illustrated in FIG. 8). Specifically, the transmission portion 35 includes a pair of pinions 36, a pair of pinions 37, and a rack 38.

In the rack 38, an elongated hole 38A is formed along the right-left direction. The rack 38 is supported to be movable in the right-left direction by the pair of shaft portions 38B being inserted into the elongated hole 38A. The rack 38 is connected to the movable shaft 39A of the drive portion 39 via a connection portion 39B.

Each of the pair of pinions 36 is attached to each of the pair of shaft portions 33. Each of the pair of pinions 37 is attached to each of the pair of shaft portions 34 and meshes with each of the pair of pinions 36. Further, one pinion 37 of the pair of pinions 37 meshes with the rack 38.

In the guide mechanism 30, as illustrated in FIG. 7, the rack 38 moves to the left side as the movable shaft 39A of the drive portion 39 moves to the left side. In a case where the rack 38 moves to the left side, the pinion 37 that meshes with the rack 38 is rotated forward in the counterclockwise direction in FIG. 7. As a result, the pair of pinions 37, and the pair of pinions 36, which mesh with the pair of pinions 37, are rotated forward, and the guide members 31 and 32 move to the discharging positions (the positions illustrated in FIG. 7).

On the other hand, as illustrated in FIG. 8, the rack 38 moves to the right side as the movable shaft 39A of the drive portion 39 moves to the right side. In a case where the rack 38 moves to the right side, the pinion 37 that meshes with the rack 38 is rotated reverse in the clockwise direction in FIG. 8. As a result, the pair of pinions 37, and the pair of pinions 36, which mesh with the pair of pinions 37, are rotated reverse, and the guide members 31 and 32 move to the carrying-in positions (the positions illustrated in FIG. 8).

First Transporting Portion 21

The first transporting portion 21 illustrated in FIG. 7 is a configuration portion that transports the recording medium P. As illustrated in FIG. 7, the first transporting portion 21 includes transporting members 23 and 25 configured as transporting rolls. In the present exemplary embodiment, for example, the transporting member 23 is defined as a driven roll and the transporting member 25 is defined as a drive roll.

Specifically, the transporting members 23 and 25 include rotation shafts 23A and 25A and roll portions 23B and 25B. The rotation shafts 23A and 25A are shaft portions extending in the front-rear direction.

Two roll portions 23B and 25B are provided (see FIG. 6). The two roll portions 23B and 25B are attached to the rotation shafts 23A and 25A at intervals in the front-rear direction such that the two roll portions 23B and 25B face each other in the up-down direction. As illustrated in FIG. 7, the roll portion 23B and the roll portion 25B are in contact with each other through an opening 14A, which is formed in the first facing member 14, and an opening 16A, which is formed in the second facing member 16.

In the first transporting portion 21, the recording medium P is transported to the right side by the transporting member 25 being rotationally driven in a state in which the recording medium P is pinched between the roll portion 23B of the transporting member 23 and the roll portion 25B of the transporting member 25. In the present exemplary embodiment, the roll portion 23B of the transporting member 23 is constantly positioned at a contact position where the roll portion 23B of the transporting member 25 is in contact with the roll portion 25B of the transporting member 25.

A transporting roll is used in the first transporting portion 21, but the transporting roll is not limited thereto. As an example of the transporting portion, a configuration may be used in which a transporting belt or the like is used, or a configuration having a member capable of transporting the recording medium P by applying a transporting force to the recording medium P may be used.

Second Transporting Portion 22

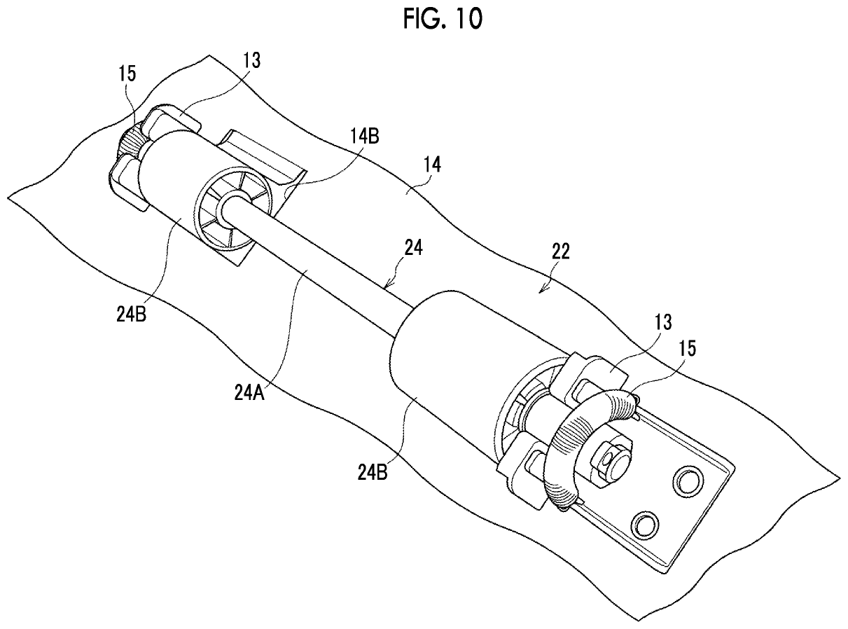

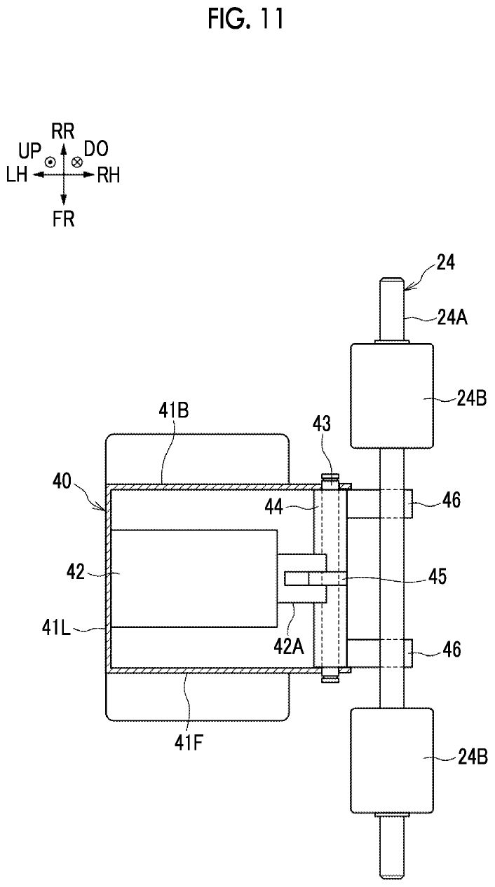

FIG. 9 is a side view illustrating an outline of the second transporting portion 22 and the movement mechanism 40. FIG. 10 is a perspective view illustrating an outline of the second transporting portion 22. FIG. 11 is a plan cross-sectional view illustrating an outline of the second transporting portion 22 and the movement mechanism 40.

The second transporting portion 22 illustrated in FIGS. 9 to 11 is an example of a transporting portion and is a configuration portion that transports the recording medium P. As illustrated in FIG. 9, the second transporting portion 22 includes transporting members 24 and 26 configured as transporting rolls. In the present exemplary embodiment, for example, the transporting member 24 is defined as a driven roll and the transporting member 26 is defined as a drive roll.

Specifically, the transporting members 24 and 26 include rotation shafts 24A and 26A and roll portions 24B and 26B. The rotation shafts 24A and 26A are shaft portions extending in the front-rear direction.

Two roll portions 24B and 26B are provided (see FIG. 9). The two roll portions 24B and 26B are attached to the rotation shafts 24A and 26A at intervals in the front-rear direction such that the two roll portions 24B and 26B face each other in the up-down direction. As illustrated in FIG. 9, the roll portion 24B and the roll portion 26B are in contact with each other through an opening 14B, which is formed in the first facing member 14, and an opening 16B, which is formed in the second facing member 16.

As illustrated in FIG. 10, both end portions of the rotation shaft 24A in the shaft direction are supported to be rotatable by a bearing 13 provided in the first facing member 14. The bearing 13 is open on the upper side, and the rotation shaft 24A is movable between a contact position (a position indicated by a solid line in FIG. 9) where the roll portion 24B and the roll portion 26B of the transporting member 26 are in contact with each other and a separation position (a position indicated by a two-dot chain line in FIG. 9) where the roll portion 24B is separated from the roll portion 26B.

Both end portions of the rotation shaft 24A in the shaft direction are held by an elastic body 15 (specifically, a coil spring), and the rotation shaft 24A is pushed to the contact position by an elastic force of the elastic body 15. Further, in FIG. 10 and FIG. 11, the bearing 13 and the elastic body 15 are not illustrated.

In the second transporting portion 22, the recording medium P is transported to the right side by the transporting member 26 being rotationally driven in a pinched state in which the recording medium P is pinched between the transporting member 24 and the transporting member 26, which are positioned in the contact positions, in the thickness direction. Further, in the second transporting portion 22, the pinched state in the second transporting portion 22 is released by the transporting member 24, which is positioned at the contact position, moving to the separation position.

Movement Mechanism 40

The movement mechanism 40 illustrated in FIG. 9 is a mechanism that moves the transporting member 24 to the separation position (the position indicated by the two-dot chain line in FIG. 9). Specifically, as illustrated in FIG. 9, the movement mechanism 40 includes a supporting body 41, a drive portion 42, a shaft portion 43, a cylindrical body 44, a connection portion 45, and an arm portion 46.

As illustrated in FIG. 9, the supporting body 41 is formed in a box shape. In FIG. 9, an outer shape of the supporting body 41 is illustrated by a broken line. As illustrated in FIG. 11, the supporting body 41 includes at least a front wall 41F, a rear wall 41B, a left wall 41L, and an upper wall (not illustrated).

The drive portion 42 is configured with a solenoid that moves the movable shaft 42A in the shaft direction. The drive portion 42 is supported by the supporting body 41 by being attached to the left wall 41L and the upper wall (not illustrated) of the supporting body 41.

The shaft portion 43 is configured with a column-shaped shaft using the front-rear direction as the shaft direction. One end portion of the shaft portion 43 in the shaft direction is attached to the front wall 41F in a state of being passed through a hollow part of the cylindrical body 44, and the other end portion of the shaft portion 43 in the shaft direction is attached to the rear wall 41B. As a result, the cylindrical body 44 is supported to be rotatable around the shaft portion 43 between the front wall 41F and the rear wall 41B.

One end portion (specifically, a lower end portion) of the connection portion 45 is fixed to the cylindrical body 44 and extends to the upper side from the cylindrical body 44. The other end portion (specifically, an upper end portion) of the connection portion 45 is rotatably connected to a tip of the movable shaft 42A around a shaft along the front-rear direction.

As illustrated in FIG. 11, two arm portions 46 are provided. As illustrated in FIG. 9, each of the two arm portions 46 protrudes from the cylindrical body 44 toward the rotation shaft 24A side (specifically, the right side) such that each of the two arm portions 46 slips to the lower side of the rotation shaft 24A of the transporting member 24.

In the movement mechanism 40, in a case where the movable shaft 42A of the drive portion 42 moves to the left side, the connection portion 45, the cylindrical body 44, and the arm portion 46 are rotated in the counterclockwise direction in FIG. 9 around the shaft portion 43, and the arm portion 46 lifts the rotation shaft 24A of the transporting member 24 against the elastic force of the elastic body 15. As a result, the transporting member 24 moves to the separation position (the position indicated by the two-dot chain line in FIG. 9).

On the other hand, in a case where the movable shaft 42A of the drive portion 42 moves to the right side, the connection portion 45, the cylindrical body 44, and the arm portion 46 are rotated reverse in the clockwise direction in FIG. 9 around the shaft portion 43, a tip of the arm portion 46 moves to the lower side, and the transporting member 24 descends due to the elastic force of the elastic body 15. As a result, the transporting member 24 moves to the contact position.

Pair of Third Transporting Portion 27

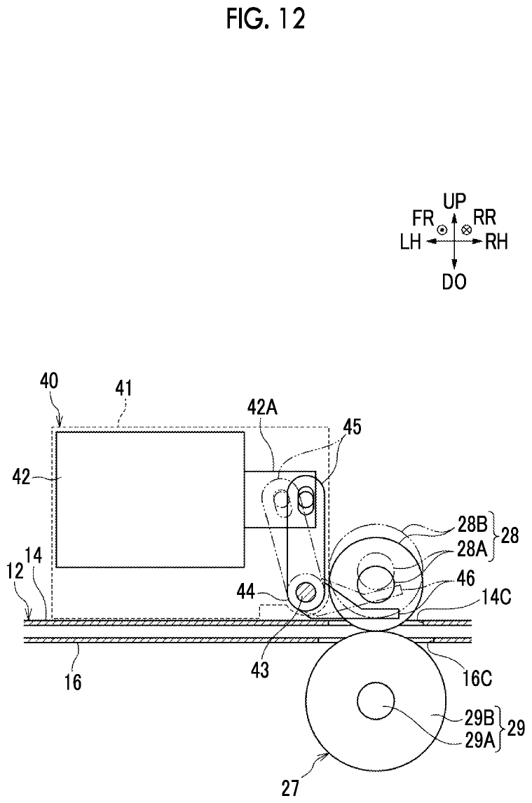

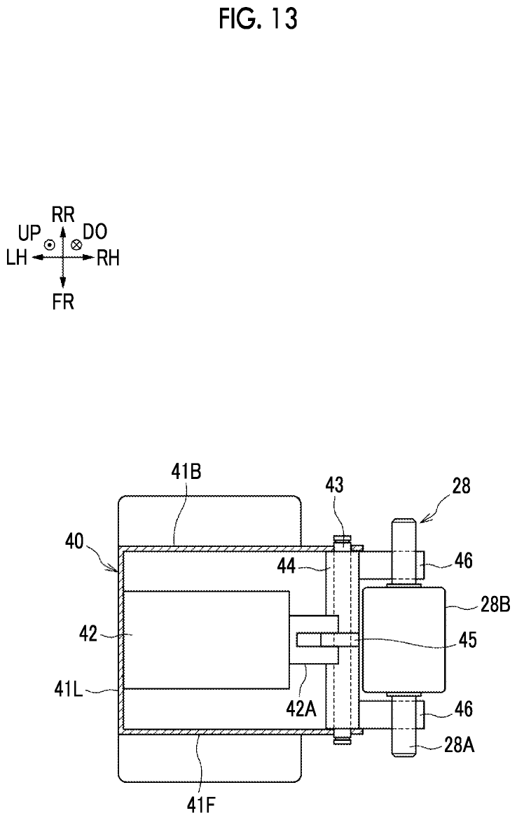

FIG. 12 is a side view illustrating an outline of the pair of third transporting portions 27 and the movement mechanism 40. FIG. 13 is a plan cross-sectional view illustrating an outline of the pair of third transporting portions 27 and the movement mechanism 40.

The pair of third transporting portions 27 illustrated in FIGS. 12 and 13 are examples of transporting portions, and are configuration portions that transport the recording medium P. The pair of third transporting portions 27 are disposed so as to be separated from each other in the front-rear direction with the contact member 52 of the rotation mechanism 50, which will be described later, sandwiched therebetween.

As illustrated in FIG. 12, each of the pair of third transporting portions 27 includes transporting members 28 and 29 configured as transporting rolls. In the present exemplary embodiment, for example, the transporting member 28 is defined as a driven roll and the transporting member 29 is defined as a drive roll. The pair of third transporting portions 27 are configured in the same manner.

Specifically, as illustrated in FIG. 12, the transporting members 28 and 29 include rotation shafts 28A and 29A and roll portions 28B and 29B. The rotation shafts 28A and 29A are shaft portions extending in the front-rear direction. In the pair of third transporting portions 27, the transporting members 28 and the transporting members 29 are disposed on the same shaft, respectively.

One roll portion 28B and one roll portion 29B are provided (see FIG. 13). The one roll portion 28B and the one roll portion 29B are attached to center portions of the rotation shafts 28A and 29A in the shaft direction such that the roll portions 28B and 29B face each other in the up-down direction. As illustrated in FIG. 12, the roll portion 28B and the roll portion 29B are in contact with each other through an opening 14C, which is formed in the first facing member 14, and an opening 16C, which is formed in the second facing member 16.

Both end portions of the rotation shaft 28A in the shaft direction are supported to be rotatable by a bearing (not illustrated) having an opening on an upper side, as in the case of the transporting member 24 (see FIG. 10). The rotation shaft 28A is movable between a contact position (a position indicated by a solid line in FIG. 12) where the roll portion 28B is in contact with the roll portion 29B of the transporting member 29 and a separation position (a position indicated by a two-dot chain line in FIG. 12) where the roll portion 28B is separated from the roll portion 29B.

Similar to the case of the transporting member 24, in both end portions of the rotation shaft 28A in the shaft direction, the rotation shaft 28A is pushed to the contact position by the elastic force of an elastic body (not illustrated).

In the pair of third transporting portions 27, the recording medium P is transported to the right side by the transporting member 29 being rotationally driven in a pinched state in which the recording medium P is pinched between the transporting member 28 and the transporting member 29, which are positioned in the contact positions, in the thickness direction. Further, in the pair of third transporting portion 27, the pinched state in the pair of third transporting portion 27 is released by the transporting member 28, which is positioned at the contact position, moving to the separation position.

As illustrated in FIGS. 12 and 13, the movement mechanism 40 that moves the transporting member 28 to the separation position (the position indicated by the two-dot chain line in FIG. 12) is also provided for the pair of third transporting portions 27.

In the movement mechanism 40, in a case where the movable shaft 42A of the drive portion 42 moves to the left side, the connection portion 45, the cylindrical body 44, and the arm portion 46 are rotated in the counterclockwise direction in FIG. 12 around the shaft portion 43, and the arm portion 46 lifts the rotation shaft 28A of the transporting member 28 against the elastic force of the elastic body 15. As a result, the transporting member 28 moves to the separation position (the position indicated by the two-dot chain line in FIG. 12).

On the other hand, in a case where the movable shaft 42A of the drive portion 42 moves to the right side, the connection portion 45, the cylindrical body 44, and the arm portion 46 are rotated reverse in the clockwise direction in FIG. 12 around the shaft portion 43, a tip of the arm portion 46 moves to the lower side, and the transporting member 28 descends due to the elastic force of the elastic body 15. As a result, the transporting member 28 moves to the contact position.

Detection Portion 19

The detection portion 19 is a configuration portion that detects the recording medium P transported by the first transporting portion 21. Specifically, the detection portion 19 detects a tip portion of the recording medium P transported by the first transporting portion 21.

The detection portion 19 is disposed between the first transporting portion 21 and the second transporting portion 22, at a position close to the first transporting portion 21.

The detection portion 19 is configured with, for example, a non-contact type sensor such as a transmission type or a reflection type optical sensor. As an example of the detection portion, for example, a contact-type sensor that detects the recording medium P by being in contact with the recording medium P may be used, and various detection portions can be used.

The first transporting portion 21, the second transporting portion 22, and the pair of third transporting portions 27 carry the recording medium P to a predetermined carrying-in position by transporting the recording medium P under predetermined transport conditions (for example, transport time and a transport speed), based on the detection result (specifically, detection timing) obtained in a case where the detection portion 19 detects the recording medium P.

Specifically, the first transporting portion 21, the second transporting portion 22, and the pair of third transporting portions 27 transport the recording medium P to the predetermined carrying-in position in a pinched state in which the recording medium P is pinched therebetween, and stop the transporting of the recording medium P.

The carrying-in position is a position where the center portion of the recording medium P in the carrying-in direction (specifically, the right-left direction) aligns with the rotation shaft of the contact member 52, and is a position where the center portion of the recording medium P in the width direction (specifically, the front-rear direction) aligns with the rotation shaft of the contact member 52. Furthermore, the carrying-in position is a position where the center of gravity of the recording medium P aligns with the rotation shaft of the contact member 52. The center of gravity of the recording medium P is an intersection of diagonal lines of the recording medium P.

Rotation Mechanism 50

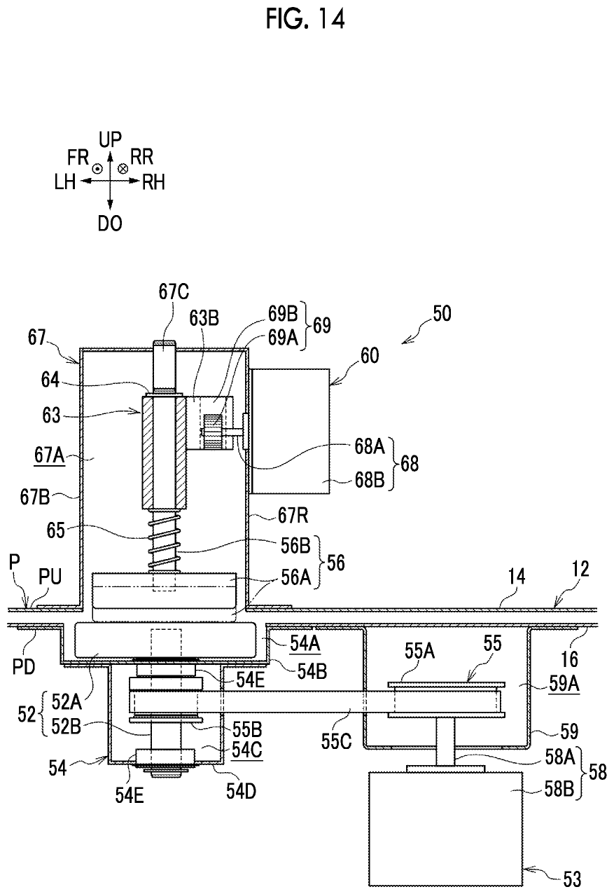

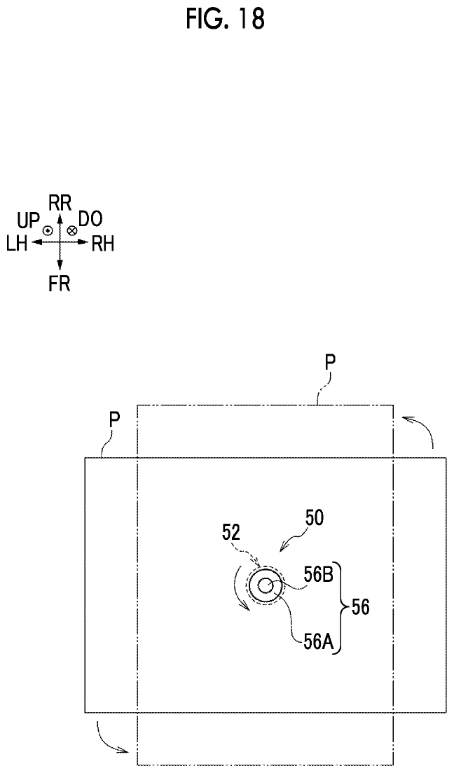

FIGS. 14 to 18 are views illustrating an outline of the rotation mechanism 50. The rotation mechanism 50 illustrated in FIGS. 14 to 18 is an example of a rotation unit, and is a mechanism that rotates the recording medium P, which is carried in by the carrying-in mechanism 20, in a view toward the thickness direction. As illustrated in FIG. 14, the rotation mechanism 50 includes the contact member 52 and the disposition member 56.

The contact member 52 is a member that can come into contact with one side (specifically, the down side PD) of the recording medium P in the thickness direction. The disposition member 56 is a member disposed on the other side (specifically, the upper side) of the recording medium P in the thickness direction. In other words, the disposition member 56 faces the other side (specifically, the up side PU) of the recording medium P in the thickness direction.

Specifically, the rotation mechanism 50 rotates the recording medium P around a predetermined rotation shaft (specifically, a rotation shaft of the contact member 52) in a view toward the thickness direction of the recording medium P. In the rotation mechanism 50, the rotation shaft, in a case where the recording medium P is rotated, may be a virtually determined rotation shaft.

The rotation mechanism 50 is configured to be capable of rotating the recording medium P in both directions of the clockwise direction and the counterclockwise direction in a view toward the thickness direction of the recording medium P. In the present exemplary embodiment, the rotation mechanism 50 rotates the recording medium Pin a range of more than 0 degrees and less than 360 degrees. Specifically, the rotation mechanism 50 rotates the recording medium Pin a range of more than 0 degrees and 180 degrees or less. More specifically, the rotation mechanism 50 rotates the recording medium P by 90 degrees in each of the clockwise direction and the counterclockwise direction in a plan view.

The rotation mechanism 50 is a separated body separated from the carrying-in mechanism 20 and the discharging mechanism 70. That is, in the present exemplary embodiment, a carrying-in function of carrying in the recording medium P, a rotation function of rotating the recording medium P, and a discharging function of discharging the recording medium P are separated from each other, and the rotation mechanism 50 does not have a function of transporting the recording medium P in the carrying-in direction (specifically, the right-left direction) and the discharging direction (specifically, the front-rear direction).

Specifically, as illustrated in FIG. 14, the rotation mechanism 50 includes a drive mechanism 53 and a movement mechanism 60 in addition to the contact member 52 and the disposition member 56.

Contact Member 52

The contact member 52 includes a contact portion 52A and a shaft portion 52B. The contact portion 52A is a part that comes into contact with the down side PD of the recording medium P and is formed in a disk shape. The contact portion 52A is formed of, for example, a material (for example, a rubber material) having a friction coefficient larger than the material of the contact portion 56A of the disposition member 56. A diameter of the contact portion 52A is set, for example, in a range of 10 mm or more and 100 mm or less.

The shaft portion 52B extends on the lower side from the contact portion 52A and is configured with a shaft using the up-down direction as the shaft direction. The shaft portion 52B is fixed to the contact portion 52A and is rotated integrally with the contact portion 52A.

The upper surface of the contact portion 52A of the contact member 52 is formed in a circular shape and comes into contact with the recording medium P on the rotation shaft (the center of rotation) of the contact member 52. In other words, the contact member 52 comes into contact with the recording medium P, which is rotated by the contact member 52, at the center of rotation.

Drive Mechanism 53

The drive mechanism 53 is a mechanism that rotationally drives the contact member 52. Specifically, the drive mechanism 53 includes a supporting portion 54, a drive portion 58, and a transmission portion 55.

The supporting portion 54 is a configuration portion that supports the contact member 52 to be rotatable. The supporting portion 54 includes, for example, a supporting body 54B having an accommodation space 54A accommodating the contact portion 52A, a supporting body 54D having an accommodation space 54C accommodating the shaft portion 52B, and a pair of bearings 54E.

The supporting body 54B is configured with, for example, a frame that is bent so as to form the accommodation space 54A and is fixed to the lower surface of the second facing member 16 of the guide portion 12. The supporting body 54B is open on the upper side to expose the upper surface of the contact portion 52A.

The supporting body 54D is configured with, for example, a frame that is bent so as to form the accommodation space 54C and is fixed to the lower surface of the supporting body 54B.

One of the pair of bearings 54E is attached to a lower wall of the supporting body 54B, and the other is attached to a lower wall of the supporting body 54D. The pair of bearings 54E supports each of one end portion and the other end portion of the shaft portion 52B of the contact member 52 to be rotatable in the shaft direction.

The drive portion 58 is a configuration portion that generates a driving force for rotating the contact member 52. Specifically, the drive portion 58 is configured with a drive motor including a drive shaft 58A and a main body portion 58B. In the present exemplary embodiment, the drive portion 58 is configured with a stepping motor as an example.

The main body portion 58B of the drive portion 58 is fixed to a fixing portion (not illustrated) configured with a frame or the like. The drive shaft 58A is a shaft using the up-down direction as the shaft direction, and extends to the upper side from the main body portion 58B toward an accommodation space 59A of an accommodation portion 59. The accommodation portion 59 is configured with, for example, a frame that is bent so as to form the accommodation space 59A and is fixed to the lower surface of the second facing member 16 of the guide portion 12.

The transmission portion 55 is a configuration portion that transmits the driving force of the drive portion 58 to the contact member 52. Specifically, the transmission portion 55 includes pulleys 55A and 55B and a timing belt 55C.

Specifically, the pulley 55A is a timing pulley and is fixed to the drive shaft 58A of the drive portion 58. Therefore, the pulley 55A is rotated integrally with the drive shaft 58A of the drive portion 58.

The pulley 55B is specifically a timing pulley and is fixed between the pair of bearings 54E in the shaft portion 52B of the contact member 52. Therefore, the pulley 55B is rotated integrally with the shaft portion 52B of the contact member 52.

The timing belt 55C is wound around the pulley 55A and the pulley 55B. As a result, in the transmission portion 55, a rotational force of the drive shaft 58A of the drive portion 58 is transmitted to the shaft portion 52B of the contact member 52 via the pulley 55A, the timing belt 55C, and the pulley 55B.

Disposition Member 56

The disposition member 56 includes a contact portion 56A and a shaft portion 56B. The contact portion 56A is a configuration portion that comes into contact with the upper side of the recording medium P and is formed in a disk shape. The contact portion 56A is disposed on the same shaft with the contact portion 52A of the contact member 52.

The contact portion 56A is formed of, for example, a material (for example, a resin material) having a friction coefficient smaller than the material of the contact portion 52A of the contact member 52. The friction coefficient of the contact portion 56A may be the same as the friction coefficient of the contact portion 52A of the contact member 52. Further, as the material of the contact portion 56A, a rubber material or the like may be used, and various materials may be used.

The contact portion 56A has a smaller diameter than the contact portion 52A of the contact member 52. Specifically, a diameter of the contact portion 56A is set, for example, in a range of 10 mm or more and 100 mm or less. The diameter of the contact portion 56A may be the same as the diameter of the contact portion 52A of the contact member 52.

The shaft portion 56B extends on the upper side from the contact portion 56A and is configured with a shaft using the up-down direction as the shaft direction. The shaft portion 56B is fixed to the contact portion 56A and is rotated integrally with the contact portion 56A.

Movement Mechanism 60

The movement mechanism 60 illustrated in FIGS. 14 to 17 is a mechanism that moves the disposition member 56. Specifically, as illustrated in FIGS. 14 to 17, the movement mechanism 60 includes a moving body 63, a limiting portion 64, a compression spring 65 as an elastic body, a supporting portion 67, a drive portion 68, and a transmission portion 69.

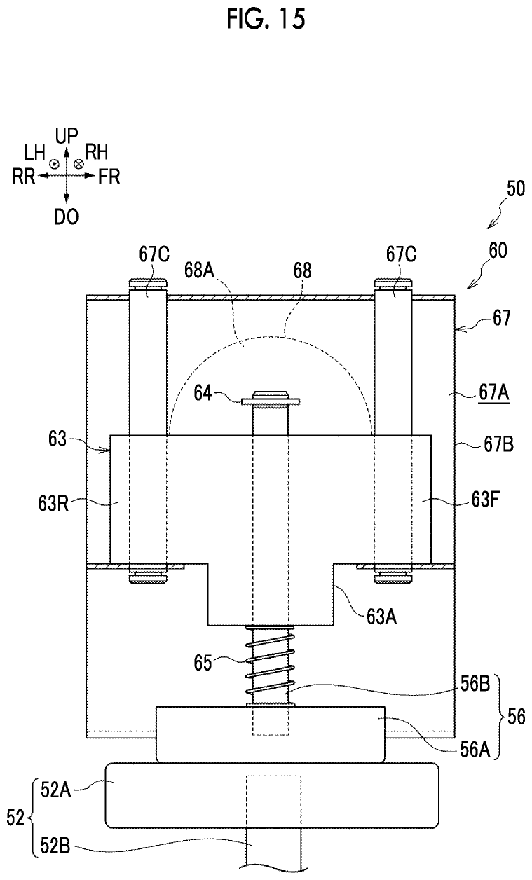

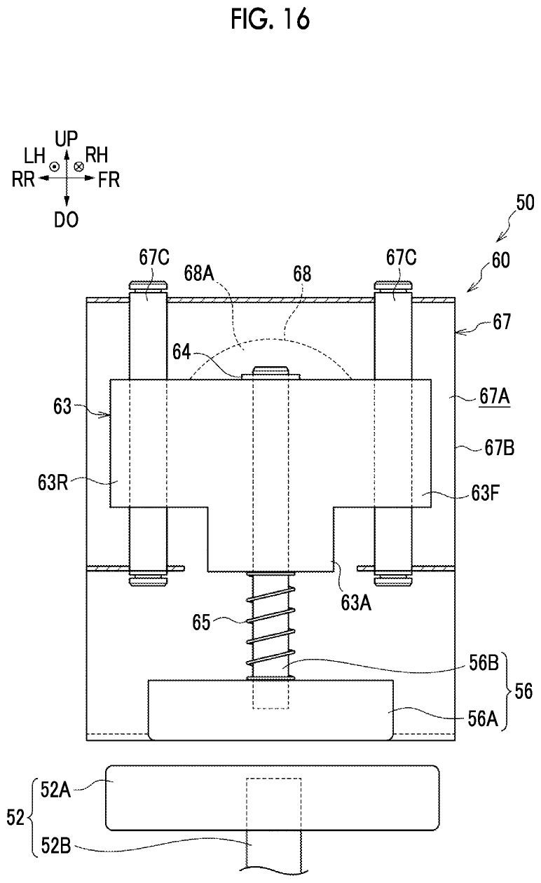

The moving body 63 is a structured body that is supported to be movable by the supporting portion 67 along the shaft direction (specifically, the up-down direction) of the shaft portion 56B in the disposition member 56 (see FIGS. 15 and 16). The moving body 63 can move the disposition member 56 along the shaft direction (specifically, the up-down direction) of the shaft portion 56B of the disposition member 56 and functions as a supporting body that supports the disposition member 56 to be rotatable around the shaft of the shaft portion 56B.

The moving body 63 is formed in a substantially T-shape having a protruding portion 63A protruding to the lower side at a center part in the front-rear direction in a side view. Further, the moving body 63 supports the disposition member 56 to be movable along the up-down direction by the shaft portion 56B of the disposition member 56 penetrating the center part of the moving body 63 in the front-rear direction in the up-down direction.

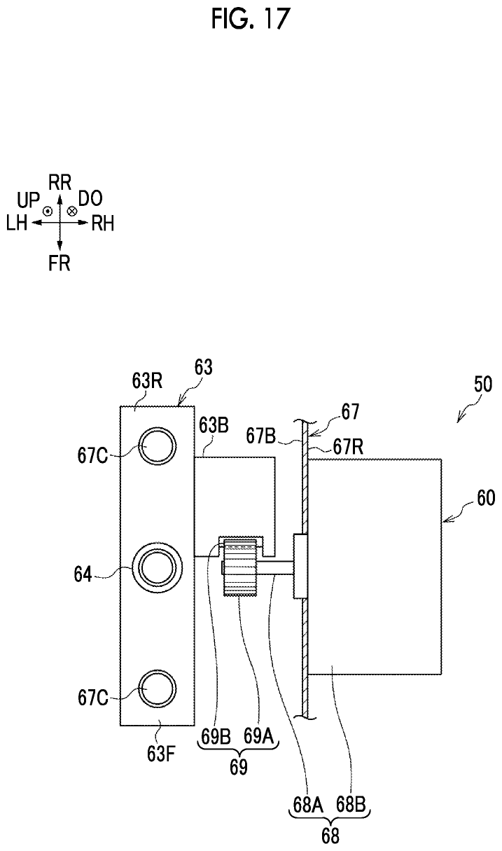

As illustrated in FIGS. 14 and 17, the moving body 63 includes a formation portion 63B on which a rack 69B described later is formed. The formation portion 63B is formed to protrude to the right side from a rear side part 63R of the moving body 63.

The limiting portion 64 is a configuration portion that limits the movement of the disposition member 56 with respect to the moving body 63 in the up-down direction. The limiting portion 64 is provided at an upper end portion of the shaft portion 56B of the disposition member 56, and is configured with an annular-shaped member that projects radially outward of the shaft portion 56B. The limiting portion 64 limits the movement of the disposition member 56 to the lower side with respect to the moving body 63 by being in contact with an upper surface of the moving body 63. The limiting portion 64 can also be said to be a retaining portion that prevents the shaft portion 56B of the disposition member 56 from coming off the moving body 63.

The compression spring 65 is provided between the contact portion 56A of the shaft portion 56B and the moving body 63. The compression spring 65 pushes the disposition member 56 to the lower side by using an elastic force.

The supporting portion 67 is a configuration portion that supports the moving body 63 to be movable in the up-down direction. A function of supporting the disposition member 56 is provided by supporting the moving body 63 that supports the disposition member 56.

Specifically, as illustrated in FIGS. 15 and 16, the supporting portion 67 includes a supporting body 67B having an accommodation space 67A that accommodates the disposition member 56, the moving body 63, and the like, and a pair of shaft portions 67C.

The supporting body 67B is configured with, for example, a frame that is bent so as to form the accommodation space 67A and is fixed to the upper surface of the first facing member 14 of the guide portion 12.

The pair of shaft portions 67C are configured with shafts using the up-down direction as the shaft direction. The pair of shaft portions 67C are attached to the supporting body 67B at an interval in the front-rear direction. The pair of shaft portions 67C penetrate a front side part 63F and the rear side part 63R of the moving body 63 in the up-down direction and support the moving body 63 to be movable in the up-down direction. Specifically, the supporting portion 67 supports the moving body 63 to be movable between the contact position (the position illustrated in FIG. 15) where the disposition member 56 is in contact with the contact member 52 and the separation position (the position illustrated in FIG. 16) where the disposition member 56 is separated from the contact member 52. In other words, the supporting portion 67 can also be said to support the disposition member 56 to be movable between the contact position (the position illustrated in FIG. 15) and the separation position (the position illustrated in FIG. 16) via the moving body 63.

The contact portion 56A of the disposition member 56 and the contact portion 52A of the contact member 52 are in contact with each other at the contact position. Furthermore, at the contact position, the contact portion 56A is pushed to the contact portion 52A by the elastic force of the compression spring 65.

At the separation position, the contact portion 56A of the disposition member 56 and the contact portion 52A of the contact member 52 are separated from each other. Specifically, at the separation position, a gap through which the recording medium P can pass is formed between the contact portion 56A and the contact portion 52A.

The drive portion 68 is a configuration portion that generates a driving force for moving the disposition member 56. Specifically, as illustrated in FIGS. 14 and 17, the drive portion 68 is configured with a drive motor including a drive shaft 68A and a main body portion 68B. Specifically, the drive portion 68 is configured with a stepping motor as an example.

The main body portion 68B of the drive portion 68 is fixed to an outer surface (specifically, the right surface) of a right wall 67R of the supporting body 67B. The drive shaft 68A is a shaft using the right-left direction as the shaft direction and extends to the left side from the main body portion 68B toward the accommodation space 67A of the supporting body 67B.

The transmission portion 69 is a configuration portion that transmits a driving force of the drive portion 68 to the moving body 63. In other words, the transmission portion 69 also can be said to transmit the driving force of the drive portion 68 to the disposition member 56 via the moving body 63. Specifically, the transmission portion 69 includes a pinion 69A and a rack 69B.

The pinion 69A is fixed to the drive shaft 68A of the drive portion 68 and is rotated integrally with the drive shaft 68A.

The rack 69B is provided on a front surface of the formation portion 63B of the moving body 63 along the up-down direction. The rack 69B and the pinion 69A mesh with each other, and the moving body 63 moves in the up-down direction as the pinion 69A is rotated forward and reverse.

In the rotation mechanism 50, in a case where the drive shaft 68A of the drive portion 68 is rotated forward, the pinion 69A is rotated forward, and the moving body 63 moves to the down side via the rack 61. As the moving body 63 moves to the down side, the disposition member 56 moves to the contact position where the disposition member 56 is in contact with the contact member 52 (see FIG. 15).

Further, in the rotation mechanism 50, in a case where the drive shaft 68A of the drive portion 68 is rotated reverse, the pinion 69A is rotated reverse, and the moving body 63 moves to the upper side via the rack 61. As the moving body 63 moves to the upper side, the disposition member 56 moves to the separation position where the disposition member 56 is separated from the contact member 52 (see FIG. 16).

Discharging Mechanism 70

The discharging mechanism 70 illustrated in FIGS. 5 and 6 is an example of the discharging unit, and is a mechanism that discharges the recording medium P, which is rotated by the rotation mechanism 50. Specifically, as illustrated in FIGS. 5 and 6, the discharging mechanism 70 includes a pair of first discharging portions 71, a second discharging portion 72, a third discharging portion 73, a fourth discharging portion 74, a fifth discharging portion 75, guide mechanisms 76 and 77, and detection portions 78 and 79.

The pair of first discharging portions 71 use the shaft direction as the right-left direction, are disposed to be separated from each other in the right-left direction with the contact members 52 therebetween, and transport the recording medium P to the rear side or the front side. Except for this point, the pair of first discharging portions 71 are configured in the same manner as the pair of third transporting portions 27. The movement mechanism 40 that moves the transporting member 28 to the separation position is also provided for the pair of first discharging portions 71.

The second discharging portion 72 is disposed on the rear side with respect to the pair of first discharging portions 71, uses the shaft direction as the right-left direction, and transports the recording medium P to the rear side. Except for this point, the second discharging portion 72 is configured in the same manner as the second transporting portion 22. The movement mechanism 40 that moves the transporting member 24 to the separation position is also provided for the second discharging portion 72.

The third discharging portion 73 is disposed on the rear side with respect to the second discharging portion 72, uses the shaft direction as the right-left direction, and transports the recording medium P to the rear side. Except for this point, the third discharging portion 73 is configured in the same manner as the first transporting portion 21.

The detection portion 78 is disposed between the second discharging portion 72 and the third discharging portion 73, at a position close to the third discharging portion 73. The detection portion 78 is configured in the same manner as the detection portion 19 except for the disposition position.

The guide mechanism 76 is provided at the discharging port 11B, and the guide members 31 and 32 are positioned at the discharging positions. Except for this point, the guide mechanism 76 is configured in the same manner as the guide mechanism 30.

The fourth discharging portion 74 is disposed on the front side with respect to the pair of first discharging portions 71, uses the shaft direction as the right-left direction, and transports the recording medium P to the front side. Except for this point, the fourth discharging portion 74 is configured in the same manner as the second transporting portion 22. The movement mechanism 40 that moves the transporting member 24 to the separation position is also provided for the fourth discharging portion 74.

The fifth discharging portion 75 is disposed on the front side with respect to the fourth discharging portion 74, uses the shaft direction as the right-left direction, and transports the recording medium P to the front side. Except for this point, the fifth discharging portion 75 is configured in the same manner as the first transporting portion 21.

The guide mechanism 77 is provided at the discharging port 11F, and the guide members 31 and 32 are positioned at the discharging positions. Except for this point, the guide mechanism 77 is configured in the same manner as the guide mechanism 30.

The detection portion 79 is disposed between the fourth discharging portion 74 and the fifth discharging portion 75, at a position close to the fifth discharging portion 75. The detection portion 79 is configured in the same manner as the detection portion 19 except for the disposition position.

Discharging Mechanism 80

The discharging mechanism 80 illustrated in FIGS. 5 and 6 is a mechanism that discharges the recording medium P, which has passed through the rotation mechanism 50 (specifically, between the contact member 52 and the disposition member 56). Specifically, the discharging mechanism 80 is a mechanism that discharges the transported recording medium P without executing a rotation operation, in the rotation mechanism 50.

Specifically, as illustrated in FIGS. 5 and 6, the discharging mechanism 80 includes a sixth discharging portion 86, a seventh discharging portion 87, a guide mechanism 88, and a detection portion 89. The pair of third transporting portions 27 constitutes a part of the discharging mechanism 80.

The sixth discharging portion 86 is disposed on the right side with respect to the pair of third transporting portions 27. The sixth discharging portion 86 is configured in the same manner as the second transporting portion 22 except for the disposition position. The movement mechanism 40 that moves the transporting member 24 to the separation position is also provided for the sixth discharging portion 86.

The seventh discharging portion 87 is disposed on the right side with respect to the sixth discharging portion 86. The seventh discharging portion 87 is configured in the same manner as the first transporting portion 21 except for the disposition position.

The guide mechanism 88 is provided at the discharging port 11R, and the guide members 31 and 32 are positioned at the discharging positions. Except for this point, the guide mechanism 88 is configured in the same manner as the guide mechanism 30.

The detection portion 89 is disposed between the sixth discharging portion 86 and the seventh discharging portion 87, at a position close to the seventh discharging portion 87. The detection portion 89 is configured in the same manner as the detection portion 19 except for the disposition position.

Transporting Operation in Transporting Device 10

In a case where the recording medium P is carried in from the carrying-in port 11L, in advance, in the pair of first discharging portions 71, the transporting member 28 is positioned at the separation position, and in the second discharging portion 72, the fourth discharging portion 74, and the sixth discharging portion 86, the transporting member 24 is positioned at the separation position. Further, in the rotation mechanism 50, in advance, the disposition member 56 is positioned at the separation position.

On the other hand, in the first transporting portion 21, the transporting member 23 is positioned at the contact position, in the second transporting portion 22, the transporting member 24 is positioned at the contact position, and in the pair of third transporting portions 27, the transporting member 28 is positioned at the contact position.

After the recording medium P, which is carried in from the carrying-in port 11L, has passed between the pair of guide members 31 and 32 in the guide mechanism 30, the first transporting portion 21, the second transporting portion 22, and the pair of third transporting portions 27 of the carrying-in mechanism 20 transport the recording medium P to a predetermined carrying-in position (that is, a stop position) in the pinched state in which the recording medium P pinched therebetween, and stop the transporting of the recording medium P.

Specifically, the first transporting portion 21, the second transporting portion 22, and the pair of third transporting portions 27 carry the recording medium P to a predetermined carrying-in position by transporting the recording medium P under predetermined transport conditions (for example, transport time and a transport speed), based on the detection result (specifically, detection timing) obtained in a case where the detection portion 19 detects the recording medium P.

As described above, the carrying-in position is a position where the center portion of the recording medium P in the carrying-in direction (specifically, the right-left direction) aligns with the rotation shaft of the contact member 52, and is a position where the center portion of the recording medium P in the width direction (specifically, the front-rear direction) aligns with the rotation shaft of the contact member 52. Furthermore, as described above, the carrying-in position is a position where the center of gravity of the recording medium P aligns with the rotation shaft of the contact member 52.

Next, in the rotation mechanism 50, the disposition member 56 is moved to the contact position. In the present exemplary embodiment, the contact member 52 starts coming into contact with the recording medium P in a state in which the movement of the recording medium P in the carrying-in direction is stopped.

By the disposition member 56 being moved to the contact position, a state becomes the pinched state in which the recording medium P is pinched between the contact member 52 and the disposition member 56 (see the two-dot chain line in FIG. 14) in the thickness direction.

Next, in the second transporting portion 22, the transporting member 24 is moved to the separation position, and in the pair of third transporting portions 27, the transporting member 28 is moved to the separation position to release the pinched state with respect to the recording medium P.

Next, in a state in which the recording medium P is pinched between the contact member 52 and the disposition member 56 in the thickness direction, the recording medium P is rotated by rotating the contact member 52 in a view toward the thickness direction of the recording medium P. As described above, in the present exemplary embodiment, the rotation mechanism 50 rotates the recording medium P in a state in which the movement of the recording medium P in the carrying-in direction (specifically, the right-left direction) is stopped.

Further, in the present exemplary embodiment, the rotation mechanism 50 rotates the recording medium P in a state in which the center portion of the recording medium P in the carrying-in direction is aligned with the rotation shaft of the contact member 52. Further, the rotation mechanism 50 rotates the recording medium P in a state in which the center portion of the recording medium P in the width direction (specifically, the front-rear direction) is aligned with the rotation shaft of the contact member 52. Further, the rotation mechanism 50 rotates the recording medium Pin a state in which the center of gravity of the recording medium P is aligned with the rotation shaft of the contact member 52.

In a case where the recording medium P is discharged from the discharging port 11B, the rotation mechanism 50 rotates the recording medium P such that the tip of the recording medium P, which faces the downstream side in the carrying-in direction, faces the discharging direction (specifically, the rear side).

Specifically, the rotation mechanism 50 rotates the recording medium P by 90 degrees in a direction at which a rotation angle (specifically, the counterclockwise direction in a plan view) until the recording medium P faces the discharging port 11B side (for example, the rear side) is smaller, among both directions of the clockwise direction and the counterclockwise direction in a plan view. The rear side is an example of a predetermined direction.

Next, in the pair of first discharging portions 71, the transporting member 28 is moved to the contact position, and in the second discharging portion 72, the transporting member 24 is moved to the contact position, and then the recording medium P is pinched therebetween.

Next, in the rotation mechanism 50, the disposition member 56 is moved to the separation position and the pinched state of the recording medium P is released.

Next, the pair of first discharging portions 71, the second discharging portion 72, and the third discharging portion 73 in the discharging mechanism 70 transport the recording medium P to the rear side in the pinched state in which the recording medium P is pinched therebetween, and discharge the recording medium P to the discharging port 11B.

That is, the discharging mechanism 70 discharges the recording medium P in the discharging direction (specifically, the rear side) that is different from the carrying-in direction in a view toward the thickness direction of the recording medium P. Further, in the present exemplary embodiment, the discharging mechanism 70 discharges the recording medium P after the rotation by the rotation mechanism 50 is stopped. Thereafter, the post-processing apparatus 140 executes the post-processing on the recording medium P.

On the other hand, in a case where the recording medium P is discharged from the discharging port 11F, the rotation mechanism 50 rotates the recording medium P such that the tip of the recording medium P, which faces the downstream side in the carrying-in direction, faces the discharging direction (specifically, the front side).

Specifically, the rotation mechanism 50 rotates the recording medium P by 90 degrees in a direction at which a rotation angle (specifically, the clockwise direction in a plan view) until the recording medium P faces the discharging port 11F side (for example, the front side) is smaller, among both directions of the clockwise direction and the counterclockwise direction in a plan view. The front side is an example of a predetermined direction.

Next, in the pair of first discharging portions 71, the transporting member 28 is moved to the contact position, and in the fourth discharging portion 74, the transporting member 24 is moved to the contact position, and then the recording medium P is pinched therebetween.

Next, in the rotation mechanism 50, the disposition member 56 is moved to the separation position and the pinched state of the recording medium P is released.

Next, the pair of first discharging portions 71, the fourth discharging portion 74, and the fifth discharging portion 75 in the discharging mechanism 70 transport the recording medium P to the front side in the pinched state in which the recording medium P is pinched therebetween, and discharge the recording medium P to the discharging port 11F. Thereafter, the post-processing apparatus 160 executes the post-processing on the recording medium P.

In a case where the recording medium P is discharged from the discharging port 11R, in the rotation mechanism 50, the pair of the third transporting portions 27, the sixth discharging portion 86, and the seventh discharging portion 87 in the discharging mechanism 80 transport the recording medium P to the right side in a pinched state in which the recording medium P is pinched therebetween and discharge the recording medium P from the discharging port 11R without executing the rotation operation. Thereafter, the post-processing apparatus 120 executes the post-processing on the recording medium P.

Supplement to Transporting Device 10

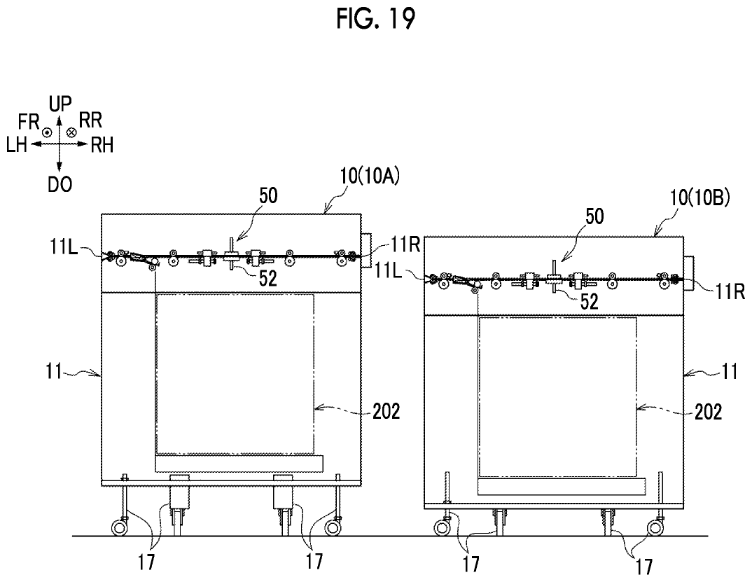

As illustrated in FIG. 19, the transporting device 10 includes a supporting portion 17 that supports the device main body 11 such that the height of the device main body 11 can be adjusted. Specifically, the supporting portion 17 is configured with leg portions with casters that support a lower portion of the device main body 11. In the supporting portion 17, the device main body 11 is moved in the up-down direction with respect to the supporting portion 17, and then the height of the device main body 11 is adjusted. As a result, the height of the device main body 11 can be adjusted according to the height of the pre-processing apparatus 110 (for example, the height of the discharging port from which the recording medium P is discharged), the height of the post-processing apparatus 120 (for example, the height of the carrying-in port into which the recording medium P is carried in), and the like. In FIG. 19, the transporting device 10, in a case where the height of the device main body 11 is adjusted to be relatively high, is indicated by the reference numeral 10A, and the transporting device 10, in a case where the height of the device main body 11 is adjusted to be relatively low, is indicated by the reference numeral 10B.

As illustrated in FIG. 19, the transporting device 10 includes an accommodation portion 202 accommodating a plurality of recording media P at a lower side part of the device main body 11. Specifically, the accommodation portion 202 is disposed on the lower side with respect to the rotation mechanism 50 (specifically, the contact member 52). The accommodation portion 202 can accommodate, for example, 100 or more, or 1000 or more (for example, substantially 5000) recording media P.

As illustrated in FIG. 5, the transporting device 10 further includes a switching portion 204 that switches a transporting path of the recording medium P and a transporting portion 206 that transports the recording medium P to the accommodation portion 202. The switching portion 204 is disposed between the carrying-in port 11L and the rotation mechanism 50 (specifically, the contact member 52). The switching portion 204 is configured with a moving member (specifically, a claw portion) that can be moved between a position where a transporting path from the carrying-in port 11L to the rotation mechanism 50 is formed and a position where a transporting path from the carrying-in port 11L to the accommodation portion 202 is formed.

The transporting portion 206 transports the recording medium P, which is guided to the accommodation portion 202 by the switching portion 204, to the accommodation portion 202. The transporting portion 206 includes a transporting member 208 such as a transporting roll and transports the recording medium P by using the transporting member 208. The transporting member 208 may be a transporting belt or the like and may be any member as long as the transporting member can transport the recording medium P by applying a transporting force to the recording medium P.

### Operations of Present Exemplary Embodiment

In the present exemplary embodiment, the rotation mechanism 50 rotates the recording medium P, which is carried in by the carrying-in mechanism 20, in a view toward the thickness direction.

Here, in a case where the recording medium P, which is carried in by the carrying-in mechanism 20, is wound around a rotation body such as a roll or a drum and is rotated in a view toward the width direction of the recording medium P (hereinafter, referred to as a form A), for example, in a case where the recording medium P is wound around the rotation body and is rotated such that the tip of the recording medium P, which faces the downstream side in the carrying-in direction, faces the upstream side in the carrying-in direction, the front and back sides of the recording medium P are reversed.

On the other hand, since the rotation mechanism 50 rotates the recording medium P in a view toward the thickness direction, the orientation of the recording medium P is changed without reversing the front and back sides of the recording medium P.

As a result, the post-processing may be executed with respect to the transporting target, in which the orientation has been changed, without reversing the front and back sides of the recording medium P for which the pre-processing has been executed by the pre-processing apparatus 110. Specifically, the post-processing may be executed with respect to the recording medium, in which the orientation has been changed, without reversing the front and back sides of the recording medium on which an image is formed by the image forming apparatus 130 in the pre-processing apparatus 110.

Further, in the present exemplary embodiment, the rotation mechanism 50 rotates the recording medium P around a predetermined rotation shaft (specifically, a rotation shaft of the contact member 52) in a view toward the thickness direction of the recording medium P.

Therefore, controlling the rotation angle is easier as compared with a case where the rotation mechanism 50 rotates the recording medium P in a state in which the rotation shaft is not fixed.

Further, in the present exemplary embodiment, the rotation mechanism 50 rotates the recording medium P in a state in which the center portion of the recording medium P in the carrying-in direction (specifically, the right-left direction) is aligned with the rotation shaft of the contact member 52.

Therefore, a space used for the rotation of the recording medium P becomes smaller as compared with a case where the rotation mechanism 50 rotates the recording medium P using an end portion of the recording medium P in the carrying-in direction as the rotation shaft.

Further, in the present exemplary embodiment, the recording medium P is rotated in a state in which the center portion of the recording medium P in the width direction (specifically, the front-rear direction) is aligned with the rotation shaft of the contact member 52.

Therefore, a space used for the rotation of the recording medium P becomes smaller as compared with a case where the rotation mechanism 50 rotates the recording medium P using the end portion of the recording medium P in the width direction as the rotation shaft.

Specifically, in the present exemplary embodiment, the rotation mechanism 50 rotates the recording medium P in a state in which the center of gravity of the recording medium P is aligned with the rotation shaft of the contact member 52.

Therefore, the space used for the rotation of the recording medium P becomes smaller as compared with a case where the rotation mechanism 50 rotates the recording medium P using a shaft passing through a position deviating from the center of gravity of the recording medium P as the rotation shaft.

Further, in the present exemplary embodiment, the rotation mechanism 50 rotates the recording medium P in a range of more than 0 degrees and less than 360 degrees. Therefore, rotation time required for rotating the recording medium P to a predetermined rotation angle is shortened as compared with a case where the rotation mechanism 50 rotates the recording medium P only in a range of more than 360 degrees.

Specifically, in the present exemplary embodiment, the rotation mechanism 50 rotates the recording medium P in a range of more than 0 degrees and 180 degrees or less. Therefore, rotation time required for rotating the recording medium P to a predetermined rotation angle is shortened as compared with a case where the rotation mechanism 50 rotates the recording medium P only in a range of more than 180 degrees.

Further, in the present exemplary embodiment, the rotation mechanism 50 is capable of rotating the recording medium P in both directions of the clockwise direction and the counterclockwise direction in a view toward the thickness direction of the recording medium P.

Therefore, the rotation time required for rotating the recording medium P to a predetermined rotation angle is shortened as compared with a case where the rotation mechanism 50 can rotate the recording medium P only in one direction.

Further, in the present exemplary embodiment, the rotation mechanism 50 rotates the recording medium P in a direction at which a rotation angle (specifically, the counterclockwise direction in a plan view) until the recording medium P faces the discharging port 11B side (for example, the rear side) is smaller, among both directions of the clockwise direction and the counterclockwise direction in a plan view.

Therefore, in a case where the rotation mechanism 50 rotates the recording medium P such that the tip of the recording medium P, which faces the downstream side in the carrying-in direction, faces a predetermined direction, the rotation time required for the tip to face the discharging port 11B side is shortened as compared with a case where the recording medium P is rotated in a direction at which a rotation angle (specifically, the clockwise direction in a plan view) until the recording medium P faces the discharging port 11B side is larger, among both directions of the clockwise direction and the counterclockwise direction in a plan view.

Further, in the present exemplary embodiment, the rotation mechanism 50 is a separated body separated from the carrying-in mechanism 20 and the discharging mechanism 70.

Therefore, a drive control of the rotation mechanism 50 is not complicated as compared with a case where the rotation mechanism 50 is integrally configured with the carrying-in mechanism 20 and the discharging mechanism 70.

In the present exemplary embodiment, the rotation mechanism 50 rotates the recording medium P such that the tip of the recording medium P, which faces the downstream side in the carrying-in direction, faces the discharging direction (specifically, the rear side).

Therefore, the discharging mechanism 70 becomes capable of discharging the recording medium P in a state in which the tip of the recording medium P, which faces the downstream side in the carrying-in direction, faces the discharging direction.

Further, in the present exemplary embodiment, the rotation mechanism 50 rotates the recording medium P in a state in which the movement of the recording medium P in the carrying-in direction (specifically, the right-left direction) is stopped.

Therefore, a rotation failure of the recording medium P is suppressed as compared with a case where the rotation mechanism 50 rotates the recording medium P in a state of being moved in the carrying-in direction.

In the present exemplary embodiment, the rotation mechanism 50 rotates the recording medium P in a state in which the pinched state between the second transporting portion 22 and the pair of third transporting portions 27 is released.

Therefore, a rotation failure of the recording medium P is suppressed as compared with a case where the rotation mechanism 50 rotates the recording medium P in a state in which the pinched state between the second transporting portion 22 and the pair of third transporting portions 27 is maintained.

Further, in the present exemplary embodiment, the discharging mechanism 70 discharges the recording medium P after the rotation by the rotation mechanism 50 is stopped.

Therefore, a discharge failure of the recording medium P is suppressed as compared with a case where the discharging mechanism 70 discharges the recording medium P in a state in which the recording medium P is being rotated by the rotation mechanism 50.

In the present exemplary embodiment, the rotation mechanism 50 rotates the recording medium P by the contact member 52 being rotated in a view toward the thickness direction of the recording medium P, in a state in which the recording medium P is pinched between the contact member 52 and the disposition member 56 (see the two-dot chain line in FIG. 14) in the thickness direction.

Therefore, a rotation failure of the recording medium P is suppressed as compared with a case where the recording medium P is rotated by the contact members 52 being rotated in a view toward the thickness direction in a state in which the recording medium P is not pinched.

Specifically, in the present exemplary embodiment, the recording medium P is rotated by both the contact member 52 and the disposition member 56 being rotated in a view toward the thickness direction of the recording medium P.

Therefore, a rotation failure of the recording medium P is suppressed as compared with a case where only the contact member 52 is rotated.

In the present exemplary embodiment, the contact member 52 comes into contact with the recording medium P at the center of rotation. Therefore, the size of the contact member 52 is reduced compared to a case where the contact member 52 comes into contact with the recording medium P at the outer periphery of the center of rotation.

Further, in the present exemplary embodiment, the contact member 52 starts coming into contact with the recording medium P in a state in which the movement of the recording medium P in the carrying-in direction is stopped.

Therefore, a rotation failure of the recording medium P is suppressed as compared with a case where the contact member 52 starts coming into contact with the recording medium P in a state in which the recording medium P is being moved in the carrying-in direction.

### Modification Example of Carrying-in Port 11L and Discharging Ports 11F, 11B, and 11R

In the present exemplary embodiment, an opening, which is formed on the left side surface of the device main body 11, is used as the carrying-in port 11L, and openings, which are formed in each of the front surface, the rear surface, and the right-left side surface of the device main body 11, are used as the discharging ports 11F, 11B, and 11R, respectively, but the present exemplary embodiment is not limited thereto. In the present exemplary embodiment, any one to three openings, among the openings that are formed on each of the left side surface, the front surface, the rear surface, and the right-left side surface of the device main body 11, can be used as the carrying-in ports, and the remaining one to three openings can be used as the discharging ports.

In this case, in the guide mechanisms 30, 76, 77, and 88, which are disposed at openings used as the carrying-in ports, the guide members 31 and 32 are positioned at the carrying-in positions (the positions illustrated in FIG. 8). Further, in the guide mechanisms 30, 76, 77, and 88, which are disposed at openings used as the discharging ports, the guide members 31 and 32 are positioned at the discharging positions (the positions illustrated in FIG. 7).

Further, in a case where the opening, which is formed on the rear surface of the device main body 11, (that is, the discharging port 11B) is used as the carrying-in port, the third discharging portion 73, the second discharging portion 72, and the pair of first discharging portions 71 can be used as the carrying-in mechanisms 20 that carry the recording medium P into the rotation mechanism 50 (specifically, the contact member 52). Further, the third discharging portion 73, the second discharging portion 72, and the pair of first discharging portions 71 can be configured to carry the recording medium P to a predetermined carrying-in position by transporting the recording medium P under predetermined transport conditions (for example, transport time and a transport speed), based on the detection result (specifically, the detection timing) obtained in a case where the detection portion 78 detects the recording medium P, and can be configured to stop the carrying-in (that is, transportation).

Further, in a case where the opening, which is formed on the front surface of the device main body 11, (that is, the discharging port 11F) is used as the carrying-in port, the fifth discharging portion 75, the fourth discharging portion 74, and the pair of first discharging portions 71 can be used as the carrying-in mechanisms 20 that carry the recording medium P into the rotation mechanism 50 (specifically, the contact member 52). Further, the fifth discharging portion 75, the fourth discharging portion 74, and the pair of first discharging portions 71 can be configured to carry the recording medium P to a predetermined carrying-in position by transporting the recording medium P under predetermined transport conditions (for example, transport time and a transport speed), based on the detection result (specifically, the detection timing) obtained in a case where the detection portion 79 detects the recording medium P, and can be configured to stop the carrying-in (that is, transportation).

Further, in a case where the opening, which is formed on the right side surface of the device main body 11, (that is, the discharging port 11R) is used as the carrying-in port, the seventh discharging portion 87, the sixth discharging portion 86, and the pair of third transporting portions 27 can be used as the carrying-in mechanisms 20 that carry the recording medium P into the rotation mechanism 50 (specifically, the contact member 52). Further, the seventh discharging portion 87, the sixth discharging portion 86, and the pair of third transporting portions 27 can be configured to carry the recording medium P to a predetermined carrying-in position by transporting the recording medium P under predetermined transport conditions (for example, transport time and a transport speed), based on the detection result (specifically, the detection timing) obtained in a case where the detection portion 89 detects the recording medium P, and can be configured to stop the carrying-in (that is, transportation).

Further, in a case where the opening, which is formed on the left side surface of the device main body 11, (that is, the carrying-in port 11L) is used as the discharging port, the pair of third transporting portions 27, the second transporting portion 22, and the first transporting portion 21 can be used as the discharging mechanisms 70 that discharge the recording medium P that is rotated by the rotation mechanism 50.

In a case where a plurality of openings, which are formed in the device main body 11, serve as carrying-in ports and a plurality of pre-processing apparatuses 110 are connected, a sending out apparatus (for example, a paper feeding apparatus that supplies paper) that sends out the transporting target can be used as the pre-processing apparatus 110. In this case, an image forming apparatus that forms an image can be used as the post-processing apparatus 120.

### Modification Example of Number of Openings in Device Main Body 11

In the present exemplary embodiment, as described above, the device main body 11 is formed with four openings, which are the carrying-in ports or the discharging ports, and is formed in a rectangular shape in a plan view, but the present exemplary embodiment is not limited thereto. For example, a configuration may be used in which the device main body 11 includes two or three openings. Further, the device main body 11 may have a configuration including five or more openings and may have a configuration including at least one or more carrying-in ports and one or more discharging ports.

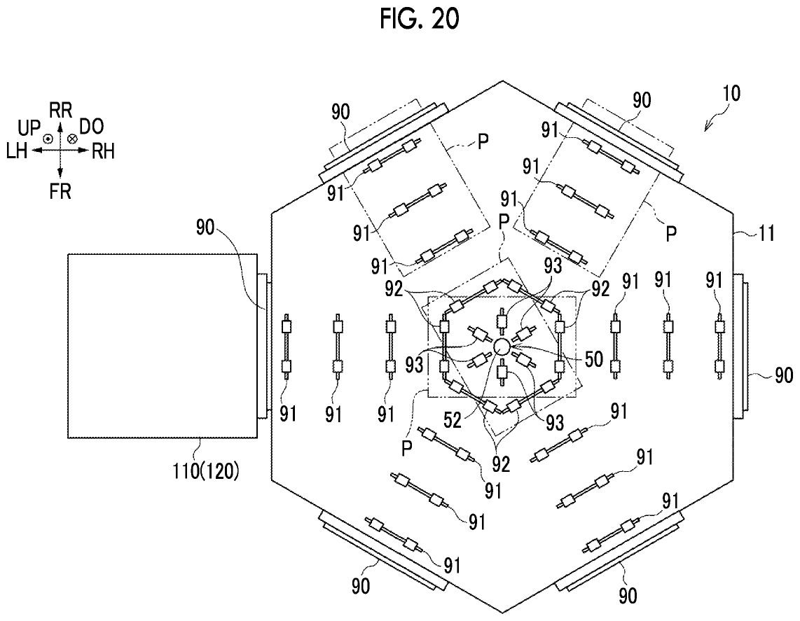

Further, as illustrated in FIG. 20, the device main body 11 is formed with six openings 90, which are the carrying-in ports or the discharging ports, and is formed in a hexagonal shape in a plan view. The configuration illustrated in FIG. 20 is configured in the same manner as the configuration formed in a rectangular shape in a plan view.

Therefore, in the configuration illustrated in FIG. 20, any one to five openings, among the six openings, can be used as the carrying-in ports, and the remaining one to five openings can be used as the discharging ports. Further, in the configuration illustrated in FIG. 20, a guide mechanism (not illustrated), which is configured in the same manner as the guide mechanism 30, is installed for each of the openings 90. In a case where the opening 90 to be installed is used as the carrying-in port, the guide mechanism is used in a state in which the guide member is positioned at the carrying-in position, and in a case where the opening 90 to be installed is used as the discharging port, the guide mechanism is used in a state in which the guide member is positioned at the discharging position.

Further, in the configuration illustrated in FIG. 20, 18 transporting portions 91, which are configured in the same manner as the first transporting portion 21, six transporting portions 92, which are configured in the same manner as the second transporting portion 22, a pair of third transporting portions 93, which are configured in the same manner as the pair of third transporting portions 27, and the rotation mechanism 50 including the contact member 52 are provided. Also in the configuration illustrated in FIG. 20, the recording medium P, which is carried in from the opening 90 that is set to the carrying-in port, is carried into the rotation mechanism 50, the rotation mechanism 50 rotates the recording medium P in a view toward the thickness direction, and then the recording medium P is discharged from the opening 90 that is set to the discharging port.

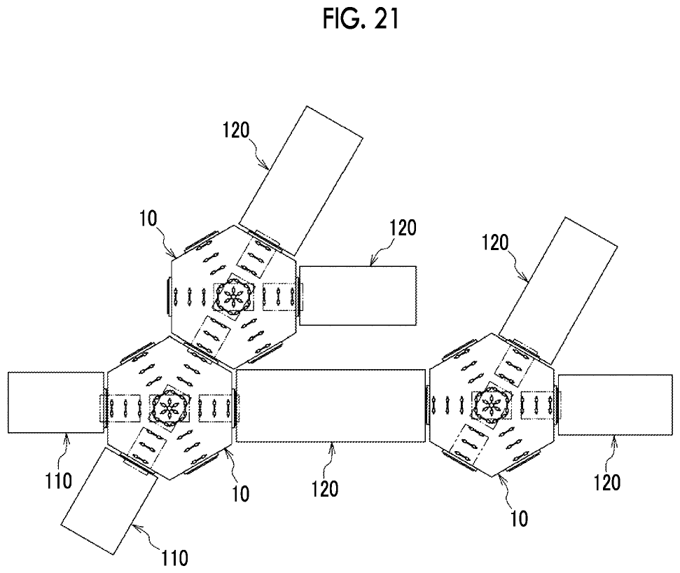

Further, in the configuration illustrated in FIG. 20, the transporting devices 10 may be continuously connected as illustrated in FIG. 21. Further, the transporting device 10 may be connected to the downstream side of the post-processing apparatus 120 that is disposed on the downstream side of the transporting device 10. Even in a configuration formed in a rectangular shape in a plan view, a configuration in which the transporting devices 10 are connected in series, and a configuration in which the transporting device 10 is connected to the downstream side of the post-processing apparatus 120 disposed on the downstream side of the transporting device 10, are applicable.

### Modification Example

In the present exemplary embodiment, in the rotation mechanism 50, the recording medium P is rotated by the contact member 52 and the disposition member 56, but the present exemplary embodiment is not limited thereto. For example, a configuration may be used in which the recording medium P is rotated by rotating the pair of third transporting portions 27, the pair of first discharging portions 71, and the supporting parts that support the pair of third transporting portions 27 and the pair of first discharging portions 71. In this case, the contact member 52 and the disposition member 56 are unnecessary, and the pair of third transporting portions 27 and the pair of first discharging portions 71 can each be configured as an integral transporting roll.

Further, in the present exemplary embodiment, the contact member 52 comes into contact with the lower side of the recording medium P, and the disposition member 56 is disposed on the upper side of the recording medium P, but the present exemplary embodiment is not limited thereto. For example, a configuration may be used in which the contact member 52 comes into contact with the upper side of the recording medium P, and the disposition member 56 is disposed on the lower side of the recording medium P.

Further, in the present exemplary embodiment, both the contact member 52 and the disposition member 56 are rotated, but the present exemplary embodiment is not limited to this. For example, the disposition member 56 may not be rotated. In this case, as the contact member 52 is rotated, the recording medium P is rotated while sliding with respect to the disposition member 56.

Further, in the present exemplary embodiment, the disposition member 56 is pushed to the contact member 52 by the compression spring 65, but the present exemplary embodiment is not limited thereto. For example, a configuration may be used in which the contact member 52 is pushed to the disposition member 56 by a compression spring 65 provided on the contact member 52.

Further, in the present exemplary embodiment, the transporting device 10 includes the disposition member 56, but the present exemplary embodiment is not limited thereto. For example, a configuration may be used in which the recording medium P is rotated by the contact member 52 being rotated in a view toward the thickness direction of the recording medium P, in a state in which the recording medium P is pinched between the contact member 52 and the first facing member 14 of the guide portion 12 in the thickness direction, without including the disposition member 56 in the transporting device 10. Further, a configuration may be used in which the contact member 52 is disposed on the upper side and rotates the recording medium P by being rotated in a view toward the thickness direction of the recording medium P, in a state in which the recording medium P is pinched between the contact member 52 and the second facing member 16 of the guide portion 12 in the thickness direction.

Further, in the present exemplary embodiment, the rotation mechanism 50 rotates the recording medium P around a predetermined rotation shaft (specifically, a rotation shaft of the contact member 52) in a view toward the thickness direction of the recording medium P, but the present exemplary embodiment is not limited thereto. For example, a configuration may be used in which the rotation mechanism 50 rotates the recording medium P in a state in which the rotation shaft is not fixed (for example, while a position of the rotation shaft changes), or a configuration may be used in which the rotation mechanism 50 rotates the recording medium P in a view toward the thickness direction.

Further, in the present exemplary embodiment, the rotation mechanism 50 rotates the recording medium P in a state in which the center portion of the recording medium P in the carrying-in direction (specifically, the right-left direction) is aligned with the rotation shaft of the contact member 52, but the present exemplary embodiment is not limited thereto. For example, a configuration may be used in which the rotation mechanism 50 rotates the recording medium P using the end portion of the recording medium P in the carrying-in direction as the rotation shaft.

Further, in the present exemplary embodiment, the recording medium P is rotated in a state in which the center portion of the recording medium P in the width direction (specifically, the front-rear direction) is aligned with the rotation shaft of the contact member 52, but the present exemplary embodiment is not limited thereto. For example, a configuration may be used in which the rotation mechanism 50 rotates the recording medium P using the end portion of the recording medium P in the width direction as the rotation shaft.

Further, in the present exemplary embodiment, the rotation mechanism 50 rotates the recording medium Pin a state in which the center of gravity of the recording medium P is aligned with the rotation shaft of the contact member 52, but the present exemplary embodiment is not limited thereto. For example, a configuration may be used in which the rotation mechanism 50 rotates the rotation mechanism 50 using the shaft passing through a position deviating from the center of gravity of the recording medium P as the rotation shaft.

Further, in the present exemplary embodiment, the rotation mechanism 50 rotates the recording medium P in a range of more than 0 degrees and 180 degrees or less, but the present exemplary embodiment is not limited thereto. For example, a configuration may be used in which the rotation mechanism 50 rotates the recording medium P only in a range of more than 180 degrees. Furthermore, a configuration may be used in which the rotation mechanism 50 rotates the recording medium P only in a range of more than 360 degrees.

Further, in the present exemplary embodiment, the rotation mechanism 50 is configured to be capable of rotating the recording medium P in both directions of the clockwise direction and the counterclockwise direction in a view toward the thickness direction of the recording medium P, but the present exemplary embodiment is not limited thereto. For example, a configuration may be used in which the rotation mechanism 50 can rotate the recording medium P in only one direction.

Further, in the exemplary embodiment, the rotation mechanism 50 rotates the recording medium P in a direction at which a rotation angle (specifically, the counterclockwise direction in a plan view) until the recording medium P faces the discharging port 11B side (for example, the rear side) is smaller, among both directions of the clockwise direction and the counterclockwise direction in a plan view, but the present exemplary embodiment is not limited thereto. For example, a configuration may be used in which the rotation mechanism 50 rotates the recording medium P in a direction at which a rotation angle (specifically, the clockwise direction in a plan view) until the recording medium P faces the discharging port 11B side is larger, among both directions of the clockwise direction and the counterclockwise direction in a plan view.

Further, in the present exemplary embodiment, in a case where the recording medium P is discharged from the discharging port 11B, the rotation mechanism 50 rotates the recording medium P such that the tip of the recording medium P, which faces the downstream side in the carrying-in direction, faces the discharging direction (specifically, the rear side), but the present exemplary embodiment is not limited thereto. For example, the recording medium P may be rotated such that a part other than the tip (for example, an upstream end in the carrying-in direction) faces the discharging direction (specifically, the rear side).

Further, in the present exemplary embodiment, in a case where the recording medium P is discharged from the discharging port 11F, the rotation mechanism 50 rotates the recording medium P such that the tip of the recording medium P, which faces the downstream side in the carrying-in direction, faces the discharging direction (specifically, the front side), but the present exemplary embodiment is not limited thereto. For example, the recording medium P may be rotated such that a part other than the tip (for example, an upstream end in the carrying-in direction) faces the discharging direction (specifically, the front side).

Further, in the present exemplary embodiment, in a case where the recording medium P is discharged from the discharging port 11R, the recording medium P is discharged in a state in which the tip of the recording medium P, which faces the downstream side in the carrying-in direction, faces the discharging direction (specifically, the right side) without executing the rotation operation in the rotation mechanism 50, but the present exemplary embodiment is not limited thereto. For example, the recording medium P may be discharged from the discharging port 11R after the recording medium P is rotated such that a part other than the tip (for example, an upstream end in the carrying-in direction) faces the discharging direction (specifically, the right side).

Further, in the present exemplary embodiment, the rotation mechanism 50 is a separated body separated from the carrying-in mechanism 20 and the discharging mechanism 70, but the present exemplary embodiment is not limited thereto. For example, the rotation mechanism 50 may be integrally configured with the carrying-in mechanism 20 and the discharging mechanism 70.

Further, in the present exemplary embodiment, the rotation mechanism 50 rotates the recording medium P in a state in which the movement of the recording medium P in the carrying-in direction (specifically, the right-left direction) is stopped, but the present exemplary embodiment is not limited thereto. For example, a configuration may be used in which the rotation mechanism 50 rotates the recording medium P in a state of being moved in the carrying-in direction.

Further, in the present exemplary embodiment, the rotation mechanism 50 rotates the recording medium P in a state in which the pinched state between the second transporting portion 22 and the pair of third transporting portions 27 is released, but the present exemplary embodiment is not limited thereto. For example, a configuration may be used in which the rotation mechanism 50 rotates the recording medium P in a state in which the pinched state between the second transporting portion 22 and the pair of third transporting portions 27 is maintained.

Further, in the present exemplary embodiment, the discharging mechanism 70 discharges the recording medium P after the rotation by the rotation mechanism 50 is stopped, but the present exemplary embodiment is not limited thereto. For example, a configuration may be used in which the discharging mechanism 70 discharges the recording medium P in a state in which the recording medium P is being rotated by the rotation mechanism 50.

In the present exemplary embodiment, the rotation mechanism 50 rotates the recording medium P by the contact member 52 being rotated in a view toward the thickness direction of the recording medium P, in a state in which the recording medium P is pinched between the contact member 52 and the disposition member 56 (see the two-dot chain line in FIG. 14) in the thickness direction, but the present exemplary embodiment is not limited thereto. For example, a configuration may be used in which the recording medium P is rotated by the contact member 52 being rotated in a view toward in the thickness direction in a state in which the recording medium P is not pinched.

Further, in the present exemplary embodiment, the recording medium P is rotated by both the contact member 52 and the disposition member 56 being rotated in a view toward the thickness direction of the recording medium P, but the present exemplary embodiment is not limited thereto. For example, a configuration may be used in which only the contact member 52 is rotated.

Further, in the present exemplary embodiment, the contact member 52 comes into contact with the recording medium P at the center of rotation, but the present exemplary embodiment is not limited thereto. For example, a configuration may be used in which the contact member 52 comes into contact with the recording medium P at the outer periphery of the center of rotation (for example, a configuration formed in an annular shape).

Further, in the present exemplary embodiment, the contact member 52 starts coming into contact with the recording medium P in a state in which the movement of the recording medium P in the carrying-in direction is stopped, but the present exemplary embodiment is not limited thereto. For example, a configuration may be used in which the contact member 52 starts coming into contact with the recording medium P in a state in which the recording medium P is being moved in the carrying-in direction.

The exemplary embodiment of the present invention is not limited to the above-described exemplary embodiment, and various modifications, changes, and improvements can be made within a range that does not deviate from the gist thereof. For example, a plurality of the modification examples illustrated above may be combined and configured as appropriate.

Supplementary Note

(((1)))

A transporting device comprising:
a carrying-in unit that carries in a sheet-shaped transporting target;
a rotation unit that rotates the transporting target, which is carried in by the carrying-in unit, in a view toward a thickness direction; and
a discharging unit that discharges the transporting target rotated by the rotation unit.

(((2)))

The transporting device according to (((1))),
wherein the rotation unit rotates the transporting target around a predetermined rotation shaft in a view toward the thickness direction.

(((3)))

The transporting device according to (((2))),
wherein the rotation unit rotates the transporting target in a state in which a center of gravity of the transporting target is aligned with the rotation shaft.

(((4)))

The transporting device according to (((2))),
wherein the rotation unit rotates the transporting target in a state in which a center portion of the transporting target in a carrying-in direction is aligned with the rotation shaft.

(((5)))

The transporting device according to (((2))),
wherein the rotation unit rotates the transporting target in a state in which a center portion of the transporting target in a width direction is aligned with the rotation shaft.

(((6)))

The transporting device according to any one of (((1))) to (((5))),
wherein the rotation unit rotates the transporting target within a range of more than 0 degrees and less than 360 degrees.

(((7)))

The transporting device according to (((6))),
wherein the rotation unit rotates the transporting target within a range of more than 0 degrees and 180 degrees or less.

(((8)))

The transporting device according to any one of (((1))) to (((7))),
wherein the rotation unit is capable of rotating the transporting target in both directions of a clockwise direction and a counterclockwise direction, in a view toward the thickness direction.

(((9)))

The transporting device according to (((8))),
wherein the rotation unit rotates the transporting target in a direction, at which a rotation angle until the transporting target faces a predetermined direction is smaller, among the both directions.

(((10)))

The transporting device according to any one of (((1))) to (((9))),
wherein the rotation unit is a separated body separated from the carrying-in unit and the discharging unit.

(((11)))

The transporting device according to any one of (((1))) to (((10))),
wherein the discharging unit discharges the transporting target in a discharging direction different from a carrying-in direction used by the carrying-in unit, in a view toward the thickness direction, and
the rotation unit rotates the transporting target such that a tip of the transporting target, which faces a downstream side in the carrying-in direction, faces the discharging direction.

(((12)))

The transporting device according to any one of (((1))) to (((11))),
wherein the rotation unit rotates the transporting target in a state in which a movement of the transporting target by the carrying-in unit in a carrying-in direction is stopped.

(((13)))

The transporting device according to (((12))),
wherein the carrying-in unit includes a transporting portion that transports the transporting target in a pinched state in which the transporting target is pinched in the thickness direction, and
the rotation unit rotates the transporting target in a state in which the pinched state of the transporting portion is released.

(((14)))

The transporting device according to any one of (((1))) to (((13))),
wherein the discharging unit discharges the transporting target after a rotation by the rotation unit is stopped.

(((15)))

The transporting device according to any one of (((1))) to (((14))),
wherein the rotation unit
   includes a contact member capable of coming into contact with one side of the transporting target in the thickness direction, and
   rotates the transporting target by the contact member being rotated in a view toward the thickness direction in a state in which the transporting target is pinched between the contact member and a disposition member, which is disposed on the other side of the transporting target in the thickness direction.

(((16)))

The transporting device according to (((15))),
wherein the rotation unit
   includes the disposition member, and
   rotates the transporting target by the contact member and the disposition member being rotated in a view toward the thickness direction in a state in which the transporting target is pinched between the contact member and the disposition member.

(((17)))

The transporting device according to (((15))),
wherein the contact member comes into contact with the transporting target at a center of rotation.

(((18)))

The transporting device according to claim (((15))),
wherein the contact member comes into contact with the transporting target at a center of rotation.

(((19)))

A processing system comprising:
a pre-processing apparatus that executes pre-processing on a transporting target;
a post-processing apparatus that executes post-processing on the transporting target; and
the transporting device according to any one of (((1))) to (((18))) that transports the transporting target, which is transported from the pre-processing apparatus, to the post-processing apparatus.

(((20)))

The processing system according to (((19))),
wherein the pre-processing apparatus includes an image forming apparatus that forms an image on a recording medium, which is used as the transporting target.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transporting device comprising:
a carrying-in unit that carries in a sheet-shaped transporting target;
a rotation unit that rotates the transporting target, which is carried in by the carrying-in unit, in a view toward a thickness direction; and
a discharging unit that discharges the transporting target rotated by the rotation unit.

2. The transporting device according to claim 1,
wherein the rotation unit rotates the transporting target around a predetermined rotation shaft in a view toward the thickness direction.

3. The transporting device according to claim 2,
wherein the rotation unit rotates the transporting target in a state in which a center of gravity of the transporting target is aligned with the rotation shaft.

4. The transporting device according to claim 2,
wherein the rotation unit rotates the transporting target in a state in which a center portion of the transporting target in a carrying-in direction is aligned with the rotation shaft.

5. The transporting device according to claim 2,
wherein the rotation unit rotates the transporting target in a state in which a center portion of the transporting target in a width direction is aligned with the rotation shaft.

6. The transporting device according to claim 1,
wherein the rotation unit rotates the transporting target within a range of more than 0 degrees and less than 360 degrees.

7. The transporting device according to claim 6,
wherein the rotation unit rotates the transporting target within a range of more than 0 degrees and 180 degrees or less.

8. The transporting device according to claim 1,
wherein the rotation unit is capable of rotating the transporting target in both directions of a clockwise direction and a counterclockwise direction, in a view toward the thickness direction.

9. The transporting device according to claim 8,
wherein the rotation unit rotates the transporting target in a direction, at which a rotation angle until the transporting target faces a predetermined direction is smaller, among the both directions.

10. The transporting device according to claim 1,
wherein the rotation unit is a separated body separated from the carrying-in unit and the discharging unit.

11. The transporting device according to claim 1,
wherein the discharging unit discharges the transporting target in a discharging direction different from a carrying-in direction used by the carrying-in unit, in a view toward the thickness direction, and
the rotation unit rotates the transporting target such that a tip of the transporting target, which faces a downstream side in the carrying-in direction, faces the discharging direction.

12. The transporting device according to claim 1,
wherein the rotation unit rotates the transporting target in a state in which a movement of the transporting target by the carrying-in unit in a carrying-in direction is stopped.

13. The transporting device according to claim 12,
wherein the carrying-in unit includes a transporting portion that transports the transporting target in a pinched state in which the transporting target is pinched in the thickness direction, and
the rotation unit rotates the transporting target in a state in which the pinched state of the transporting portion is released.

14. The transporting device according to claim 1,
wherein the discharging unit discharges the transporting target after a rotation by the rotation unit is stopped.

15. The transporting device according to claim 1,
wherein the rotation unit
includes a contact member capable of coming into contact with one side of the transporting target in the thickness direction, and
rotates the transporting target by the contact member being rotated in a view toward the thickness direction in a state in which the transporting target is pinched between the contact member and a disposition member, which is disposed on the other side of the transporting target in the thickness direction.

16. The transporting device according to claim 15,
wherein the rotation unit
includes the disposition member, and
rotates the transporting target by the contact member and the disposition member being rotated in a view toward the thickness direction in a state in which the transporting target is pinched between the contact member and the disposition member.

17. The transporting device according to claim 15,
wherein the contact member comes into contact with the transporting target at a center of rotation.

18. The transporting device according to claim 15,
wherein the contact member starts coming into contact with the transporting target in a state in which a movement of the transporting target by the carrying-in unit in a carrying-in direction is stopped.

19. A processing system comprising:
a pre-processing apparatus that executes pre-processing on a transporting target;
a post-processing apparatus that executes post-processing on the transporting target; and
the transporting device according to claim 1 that transports the transporting target, which is transported from the pre-processing apparatus, to the post-processing apparatus.

20. The processing system according to claim 19,
wherein the pre-processing apparatus includes an image forming apparatus that forms an image on a recording medium, which is used as the transporting target.
